(19) United States
(12) Patent Application Publication
(10) Pub. No.: US 2011/0008573 A1
(43) Pub. Date: Jan. 13, 2011

(54) SHEET OF MATERIAL WITH BEND-CONTROLLING STRUCTURES AND METHOD

(75) Inventor: Max W. Durney, San Francisco, CA (US)

Correspondence Address: K&L Gates LLP;IP Docketing, 630 HANSEN WAY, PALO ALTO, CA, 94304, US

(73) Assignee: Industrial Origami, Inc., San Francisco, CA (US)

(21) Appl. No.: 12/703,654

(22) Filed: Feb. 10, 2010

Related U.S. Application Data
(60) Provisional application No. 61/151,400, filed on Feb. 10, 2009.
(60) Provisional application No. 61/251,182, filed on Oct. 13, 2009.

(51) Int. Cl. B32B 3/10; B26F 1/24; B31F 1/00; B21D 31/00

(52) U.S. Cl. 428/131; 83/30; 493/395; 72/379.2

(57) ABSTRACT

A two-dimensional sheet of material for bending along a bend line to form a three-dimensional article having a load-bearing bend line, the sheet including at least one bend-controlling displacement. The displacement includes a displaced portion displaced from the sheet of material in a thickness direction defined by a sheared face, the displaced portion further including a central portion extending along the bend line and opposing end portions at opposite ends of the central portion; and a stem portion interconnecting the displaced portion to the remainder of the sheet of material. The stem portion is located inwardly of the end portions and defined by opposing termini of the sheared face. In various aspects, the displacements are formed in opposite thickness directions and configured to promote bi-directional precision folding. Methods of forming and using the sheet of material are also described.

### CROSS-REFERENCES TO RELATED APPLICATIONS

This application claims priority to U.S. Provisional Patent Application No. 61/151,400 filed Feb. 10, 2009 and entitled SHEET OF MATERIAL WITH BEND-CONTROLLING STRUCTURES AND METHOD, and to U.S. Provisional Patent Application No. 61/251,182 filed Oct. 13, 2009 and entitled SHEET OF MATERIAL WITH BEND-CONTROLLING STRUCTURES AND METHOD, the entire contents of which applications is incorporated herein for all purposes by this reference.

### BACKGROUND OF THE INVENTION

1. Field of the Invention

This invention relates, in general, to preparing a sheet of material for bending along a bend line into a three-dimensional structure.

2. Description of Related Art

The present invention is related to techniques for preparing a sheet of material to bend or fold along a desired bend line. Such techniques are disclosed in depth in U.S. Pat. Nos. 7,152,449, 7,032,426, 6,877,349, 6,481,259, and 7,263,869, all to Durney et al., as well as U.S. patent application Ser. No. 11/927,666 filed Oct. 29, 2007 (now U.S. Patent Application Publication No. 2008-0193714 A1) and U.S. patent application Ser. No. 11/290,968 filed Nov. 29, 2005 (U.S. Patent Application Publication No. 2006-0075798 A1), hereinafter referred to collectively as “Related Patents and Applications”, which patents and patent applications are each incorporated herein for all purposes by reference in their entireties. In these applications several techniques and manufacturing processes for forming slits, displacements, and/or grooves that will precisely control bending of sheet material are disclosed.

These innovative slitting and displacement techniques allow preparation of a sheet of material in two dimensions for folding along a precisely-located bend line. These techniques, however, have thus far focused on preparing a sheet for bending along a bend line in only one direction. The Related Patents and Applications further disclose several techniques for preparing a sheet for bending by providing visual clues or physical indicators to a user as to which direction to bend the sheet. The Related Patents and Applications disclose exemplary displacements. Accordingly, such displacements are intended to rotate to engage material on an opposite side of the bend line during bending. Traditionally, the bending direction is determined before the sheet of material is prepared. Thereafter, the displacements are punched in one thickness direction such that each of the displacements facilitates precision bending of the two-dimensional sheet in the predetermined bending direction. In other words, the prepared two-dimensional sheet is informed with information related to the bending process.

The above techniques are limited in that the sheets are prepared for bending in a predetermined direction. Thus, in some cases, a separate sheet of material must be prepared for a left-hand part and a right-hand part. This requires users to know which direction to fold the prepared sheet of material. Additionally, the benefits of the sheet preparation are lost if a user bends the sheet in the wrong or unintended direction.

There is a need for techniques to prepare a sheet of material in two dimensions for precision folding in multiple directions along a precisely-located bend line to form a three-dimensional article. There is also a continuing need to improve sealing and/or load conditions along the bend lines of such three-dimensional articles.

The existing folding techniques are also limited to use of particular materials. The above techniques work well with generally ductile materials but are less effective with brittle materials and materials with less ductility and/or higher tensile strength. For example, such techniques may result in high stresses after bending when used with materials such as 2.0 mm thick T-6 aluminum. As such, existing techniques have limited application with relatively high tensile strength materials. Additionally, the occurrence of stresses and concentration of stresses near locations where the material is working generally leads to lower fatigue strength and increased risk of failure of the bend line and article to be formed.

In light of the foregoing, it would be beneficial to have methods and apparatuses which overcome the above and other disadvantages of known sheet materials.

### BRIEF SUMMARY OF THE INVENTION

Various aspects of the present invention are directed to a two-dimensional sheet of material for bending along a bend line to form a three-dimensional article having a load-bearing bend line, the sheet including at least one bend-controlling displacement. The at least one bend-controlling displacement includes a displaced portion displaced from the sheet of material in a thickness direction defined by a sheared face, the displaced portion further including a central portion extending along the bend line and opposing end portions at opposite ends of the central portion; and a stem portion interconnecting the displaced portion to the remainder of the sheet of material, wherein the stem portion is located inwardly of the end portions and defined by opposing termini of the sheared face.

In various embodiments, a maximum displacement distance of the central portion is at least approximately equal to the thickness of the sheet of material. In various embodiments, the central portion includes a planar zone substantially parallel to the sheet of material. The central portion may further include opposing inclined portions extending from the planar zone. The opposing ends may define respective inclined portions.

In various embodiments, the end portions extend at an angle between approximately 5° and approximately 10° relative to the surface of the sheet of material. In various embodiments, the outermost edges of the end portions are displaced a distance less than the thickness of the sheet of material.

In various embodiments, the stem portion interconnects the displaced portion to the sheet along an interconnecting region partially defined by one or more ribs. The interconnecting region may be defined by opposing semispherical ribs located adjacent respective termini.

In various embodiments, the sheet of material includes a plurality of displacements, wherein successive displacements are positioned on alternating sides of the bend line. In various embodiments, the sheet includes a plurality of displacements, wherein adjacent displacements define bending straps therebetween. The end portions may include a substantially linear segment positioned and configured such that respective end portions of adjacent displacements on opposite sides of the bend line define substantially quadrilateral bending straps.

Various aspects of the present invention are directed to a method of preparing a two-dimensional sheet of material for bending along a bend line to form a three-dimensional article, the method including forming at least one bend-controlling displacement defining a bend line, the displacement including a displaced portion displaced from the sheet of material in a thickness direction defined by a sheared face, the displaced portion further including a central portion extending along the bend line and opposing end portions at opposite ends of the central portion; and a stem portion interconnecting the displaced portion to the remainder of the sheet of material, wherein the stem portion is located inwardly of the end portions and defined by opposing termini of the sheared face.

In various embodiments, the method includes bending the sheet of material along the bend line whereby a balancing of the forces during bending draws a surface of the sheet on an opposite side of the bend line from the at least one displacement into engagement with the sheared face. During the forming, a maximum displacement distance of the central portion may be at least approximately equal to the thickness of the sheet of material.

The forming may include forming the central portion with a planar zone substantially parallel to the sheet of material. The forming may include forming the central portion with opposing inclined portions extending from the planar zone. The opposing ends may define respective inclined portions. The outermost edges of the end portions may be displaced a distance less than the thickness of the sheet of material.

The stem portion may interconnect the displaced portion to the sheet along an interconnecting region partially defined by one or more ribs. The interconnecting region may be defined by opposing semispherical ribs located adjacent respective termini.

The forming may include forming the sheet of material with a plurality of displacements, wherein successive displacements are positioned on alternating sides of the bend line. The forming may include forming the sheet with a plurality of displacements, wherein adjacent displacements define bending straps therebetween.

Each of the end portions may include a substantially planar segment positioned and configured such that respective end portions of adjacent displacements on opposite sides of the bend line define substantially quadrilateral bending straps.

Various aspects of the present invention are directed to a method of forming a 3D article from a two-dimensional sheet of material, the method comprising forming a plurality of bend-controlling displacements to define a bend line in a two-dimensional sheet of material, at least a portion of the periphery of each displacement defining a sheared face, the forming including displacing at least one bend-controlling displacement in one thickness direction of the sheet and displacing another bend-controlling displacement in an opposite thickness direction of the sheet; and precision bending a portion of the sheet of material along the bend line.

The plurality of bend-controlling displacements may be positioned and configured to promote precision bending along the bend line in multiple directions. In various embodiments, the bending produces a balancing of the forces to draw the sheared face into engagement with a surface of the sheet on an opposite side of the bend line from the at least one displacement.

In various embodiments, the method further comprises preparing a second two-dimensional sheet of material substantially identical to the first sheet of material for bending along a bend line corresponding to the first sheet of material bend line; and precision bending a portion of the second sheet of material along the corresponding bend line of the second sheet of material in a direction opposite to the bending of the first sheet of material. The bent first sheet of material may be positioned on top of the bent, second sheet of material such that a bent portion along the bend line of the first sheet of material is adjacent to an opposing bent portion along the bend line of the second sheet of material. The first sheet of material may be fastened to the second sheet of material to form a rigid, three-dimensional article. The fastening may be accomplished by interference fit. The bend lines on the first and second sheets of material may be positioned and configured such that at least one of the bent portions on the first sheet engages a corresponding bent portion on the second sheet during the positioning.

In various embodiments, the sheet material is non-compressible. In various embodiments, the sheet material is a ductile metal.

In various embodiments, during the forming, a maximum displacement distance of the displacement is approximately equal to the thickness of the sheet of material. The maximum displacement may be on a central portion of the displacement and end portions of the displacements are displaced a distance less than the thickness of the sheet of material. The forming may include forming a central portion of the displacement with a planar zone substantially parallel to the sheet of material. The forming may include forming the central portion with opposing inclined portions extending from the planar zone to the remainder of the sheet of material.

In various embodiments, successive displacements are positioned on the same side of the bend line. Adjacent displacements may define bending straps therebetween. Respective ends of adjacent displacements may define bending half-straps.

Various aspects of the invention are directed to a two-dimensional sheet of material for precision bending along a bend line to form a three-dimensional article, the sheet comprising a plurality of bend-controlling displacements displaced from the sheet of material in a thickness direction, at least a portion of the periphery of each displacement defining a sheared face, wherein at least one of the plurality of bend-controlling displacement is displaced in one thickness direction and at least another of the plurality of bend-controlling displacements is displaced in an opposite thickness direction.

In various embodiments, the one and another displacement are displaced in a direction substantially orthogonal to a plane defined by the sheet of material prior to bending. A maximum displacement distance of the one and another displacement may be approximately equal to the thickness of the sheet of material. Successive displacements may be positioned on the same side of the bend line. Successive displacements may be displaced on alternating sides of the sheet of material. Successive displacements may be displaced on alternating sides of the sheet of material.

Various aspects of the present invention are directed to a method of forming a three-dimensional article from a two-dimensional sheet of material, the method comprising preparing a two-dimensional sheet of material, and precision bending the sheet of material along the bend line into a three-dimensional article.

Various aspects of the present invention are directed to a rigid, three-dimensional article formed from a two-dimensional sheet of material, the article comprising a first sheet of material bent along at least one bend line defined by a plurality of bend-controlling displacements, at least a portion of the periphery of each displacement defining a sheared face, at least one bend-controlling displacement being formed in one thickness direction of the sheet prior to bending and at least another bend-controlling displacement being formed in an opposite thickness direction of the sheet; and a second sheet of material substantially identical to the first sheet of material, the second sheet of material being attached to the first sheet of material, wherein the second sheet of material is bent along a bend line corresponding to the at least one first sheet bend line in an opposite thickness direction, the bent first sheet of material being positioned on top of the bent second sheet of material such that a bent portion defined by the bend line of the first sheet of material opposes a bent portion defined by the corresponding bend line of the second sheet of material. In various embodiments, the first and second sheets of material are fastened together.

Various aspects of the present invention are directed to a method of forming a rigid, three-dimensional article, the method comprising preparing a first sheet of material for bending along a bend line defined by a plurality of displacements formed in a thickness direction of the sheet; preparing a second sheet of material for bending along a bend line, the second sheet bend line defined by a plurality of displacements formed in a thickness direction of the sheet positioned and configured substantially identical to the first sheet of material such that the bend line in the second sheet of material corresponds to the bend line in the first sheet of material; precision bending the first sheet of material along the first sheet bend line; and precision bending the second sheet of material along the second sheet bend line in an direction to the first sheet.

In various embodiments, the method further comprises positioning the first sheet adjacent to the second sheet such that a bent portion along the bend line of the first sheet of material is opposing a bent portion along the corresponding bend line of the second sheet of material.

The sheet materials of the present invention, and the methods of forming and using the same, have other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is a perspective view of a prepared sheet of material in accordance with the present invention, illustrating the sheet prior to folding into a three-dimensional article.

FIG. 2 is a perspective view of an underside of the sheet of material of FIG. 1.

FIG. 3 is a top view of the sheet of material of FIG. 1.

FIG. 4-A is a top view of the sheet of material of FIG. 1. FIG. 4-B is a cross-sectional view of the sheet of FIG. 4-A taken along the line A-A.

FIG. 5-A is a top view of the sheet of material of FIG. 1. FIG. 5-B1 is a cross-sectional view of the sheet of FIG. 5-A taken along the line B1-B1. FIG. 5-B2 is a cross-sectional view of the sheet of FIG. 5-A taken along the line B2-B2.

FIG. 6 is a perspective view of the sheet of material of FIG. 1 after the sheet of material has been folded into a three-dimensional article.

FIG. 7 is a perspective view of a backside of the bent sheet of material of FIG. 6.

FIG. 8 is a side cross-sectional view of the bent sheet of material of FIG. 6.

FIG. 9-A is an isometric view of a rendering of a sheet of material similar to that of FIG. 1 using finite element analysis, illustrating the stresses in the sheet after forming a plurality of displacements. FIGS. 9-B to 9-C are isometric views of successive renderings of the sheet of material of FIG. 9-A during bending, illustrating accumulation of stresses in and around the displacements and bend line. FIGS. 9-D to 9-E are successive front views corresponding to FIGS. 9-B to 9-C, respectively.

FIG. 10 is a perspective view of a sheet of material similar to that of FIG. 1 after the sheet has been bent into a three-dimensional article, illustrating different displacement configurations on opposite sides of the bend line.

FIG. 11 is a perspective view of a backside of the sheet of material of FIG. 11, illustrating a rendering of stress concentrations using finite element analysis.

FIG. 12-A is a top view of a sheet of material similar to that of FIG. 1 prior to bending into a three-dimensional article, illustrating a zero jog distance. FIG. 12-B1 is a cross-sectional view of the sheet taken along the line B-B in FIG. 12-A. FIG. 12-B2 is an enlarged front view of a displacement of FIG. 12-B1 illustrating a maximum z-depth of the displacement. FIG. 12-B3 is a cross-sectional view of the displacement of FIG. 12-B2 taken along the line C-C, illustrating a central portion having a planar surface substantially parallel to the sheet of material. FIG. 12-B4 is a cross-sectional view of the displacement of FIG. 12-B2 taken along the line D-D, illustrating an inclined portion extending downward from the planar portion.

FIGS. 13-15 are top views of sheets of material similar to that of FIG. 1 having modified jog distances. FIG. 13-A is a cross-sectional view of the sheet of material of FIG. 13 taken along the line A-A. FIG. 14-A is a cross-sectional view of the sheet of material of FIG. 14 taken along the line A-A.

FIG. 16 is a perspective view of a sheet of material similar to that of FIG. 1, illustrating bend-controlling displacements with inclined portions configured to seal to the bending straps and an opposing sheet surface after bending.

FIG. 17 is a schematic top view of a sheet of material similar to that of FIG. 1, illustrating bi-directional bend lines in accordance with the present invention. FIG. 17-A1 is an enlarged view of a portion of the sheet of FIG. 17. FIG. 17-A2 is a cross-sectional view of the sheet of FIG. 17 taken along the line B-B. FIG. 17-B1 is an enlarged view of a portion of the sheet of FIG. 17. FIG. 17-C1 is an enlarged view of a portion of the sheet of FIG. 17, illustrating a displacement along an outer bend line defining a flange portion. FIG. 17-C2 is an enlarged view of a bend-controlling displacement along a bend line of FIG. 17. FIG. 17-D1 is an enlarged view of a portion of the sheet of FIG. 17, illustrating a displacement at a corner of the sheet. FIG. 17-D2 is an enlarged view of another bend-controlling displacement along a bend line of FIG. 17.

FIGS. 18-A to 18-D are sequential views of two identical sheets of material similar to that of FIG. 17, illustrating bending of the two sheets in different directions to form an exemplary three-dimensional heat shield for a cooking range. FIG. 18-D1 is a bottom perspective view of the sheets of material of FIG. 18-A after bending and fastening together to form the three-dimensional product. FIG. 18-D2 is a top perspective view of the product of FIG. 18-D1. FIG. 18-D3 is a cross-sectional view of the product of FIG. 18-D2 taken along the line D-D. FIG. 18-E is an enlarged view of the venting slots of the exemplary three-dimensional article of FIG. 18-D. FIG. 18-F is an enlarged view of a corner of the three-dimensional article of FIG. 18-D. FIG. 18-G is an enlarged view of a plurality of folded sheets similar to that of FIG. 18A, illustrating stacking of the sheets on top of each other in accordance with the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Various aspects of the present invention are directed to preparing sheets of material for bending similar to those disclosed by U.S. Pat. No. 6,481,259, U.S. Pat. No. 6,877,349, U.S. Pat. No. 7,152,449, U.S. Pat. No. 7,152,450, U.S. Pat. No. 7,350,390, U.S. Patent Application Publication No. 2005/0005670 (now U.S. Pat. No. 7,440,874), U.S. Pat. No. 7,032,426, U.S. Pat. No. 7,263,869, U.S. Pat. No. 7,222,511, U.S. Patent Application Publication No. 2006/0261139 (now U.S. Pat. No. 7,640,775), U.S. Pat. No. 7,374,810, U.S. Pat. No. 7,412,865, U.S. Pat. No. 7,350,390, U.S. Patent Application Publication No. 2006/0213245 (now U.S. Pat. No. 7,412,86), U.S. Patent Application Publication No. 2006/0021413, U.S. Patent Application Publication No. 2006/0075798, U.S. Pat. No. 7,464,574, U.S. Patent Publication No. 2009/0100894, U.S. Patent Publication No. 2009/0100895, U.S. Patent Publication No. 2006/0277965, U.S. Patent Application Publication No. 2006/0277965, U.S. Patent Publication Application No. 2008/0098787, and U.S. Patent Publication No. 2008/0098787, the entire contents of which patents and patent applications are incorporated herein for all purposes by this reference.

The aforementioned patents and applications are generally directed to preparing sheets of material for bending into three-dimensional (3D) articles by forming bend-controlling structures in the sheet. “Bend-controlling structures” refers to structures and features including, but not limited to, slits, grooves, and displacements for defining a bend line, controlling bending along a bend line, and/or inducing bending along a bend line. “Bend line” is used interchangeably with “fold line.” “Three-dimensional article” is used interchangeably with “three-dimensional structure” and “three-dimensional product” and refers generally to articles formed at least in part by bending a two-dimensional sheet along a bend line. “Slits” and “grooves” refer to a cut in the sheet or removal of material from the sheet. “Displacement” refers to a portion of the sheet which is displaced from the original plane of the unfolded sheet. In various embodiments, “displacement” refers to displacing or pushing the material in the thickness direction of the sheet. “Thickness direction” refers to a direction generally perpendicular to the original plane of the sheet. In various embodiments, “displacement” refers to pushing and working the material in the thickness direction of the sheet such that at least partial shearing of the material occurs.

Bend-controlling structures control and precisely locate the bending of a two-dimensional sheet material into three-dimensional structures. Such bend-controlling structures lower the cost and complexity of manufacturing processes and allow for greater flexibility of manufacture and time savings. Bend-controlling structures optionally allow a sheet of material to be prepared simply in-the-flat and later folded into complicated three-dimensional structures. Preparation of the sheet “in-the-flat,” meaning in the two-dimensional sheet before folding, generally decreases manufacturing complexity and time.

One will appreciate that the methods and sheets of the present invention are suitable for forming a wide variety of products including, but not limited to, electronic component chasses, automotive components, transport components, construction components, appliance parts, truck components, RF shields, HVAC components, aerospace components, toys, outdoor equipment, boats, recreational equipment, cooking appliances and components, and more. In particular, the teachings of the present application are applicable to a wide variety of 3D products and articles that are formed by folding 2D sheet materials, which products require bends with some degree of pressure tightness and/or strength. One will appreciate that the sheet of material of the present invention may be equally suited for bending into a variety of three-dimensional articles and for various applications. One will further appreciate that the folded sheets of the present inventions may be used to form 3D products and articles alone or in combination with non-folded parts. The folded products may be finished products or precursors to finished products.

Bend-controlling structures often are used in applications where it is desirable to create a rigid, three-dimensional article capable of supporting loads not only along the sheet surfaces but also along the bend line in the region of the bend-controlling structures. However, existing processes for forming bend-controlling structures such as punching, stamping, machining, photo-etching, embossing, and the like may create gaps or separations in the sheet of material after bending. While such processes may lead to some engagement of features of the sheet during bending, the engagement along the bend line may be insufficient for higher loads. For example, the surfaces in contact generally may be small and/or contact may occur at angles which limit the application of force.

Additionally, existing bend-controlling structures may not allow for bending of high-tensile strength materials which lack ductility (e.g. T-6 aluminum). Various aspects of the present inventions, therefore, illustrate how bend-controlling structures, such as bend-controlling displacements, can be formed in a sheet of material that can be bent into a three-dimensional structure, the structure having reduced stresses and increased load-bearing capacity along the bend lines. Various aspects of the present inventions are directed to forming bent, three-dimensional articles with reduced stress concentrations and increased fatigue strength. In some respects, the present inventions allow for preparing sheets of material for bending using materials with relatively higher-tensile strength. For example, the methods described herein may be applied to high-strength, brittle materials that normally would be unsuitable for bending with existing techniques.

In some respects, the present inventions are directed to preparing a sheet of material for bending with greater flexibility. For example, the methods and sheets described may be applied to prepare a sheet of material that can be bent in more than one direction or manner, such as bend lines that provide for bi-directional precision folding. By “bi-directional” it is meant that the sheet may be rotated and precision-folded in multiple directions along the fold line.

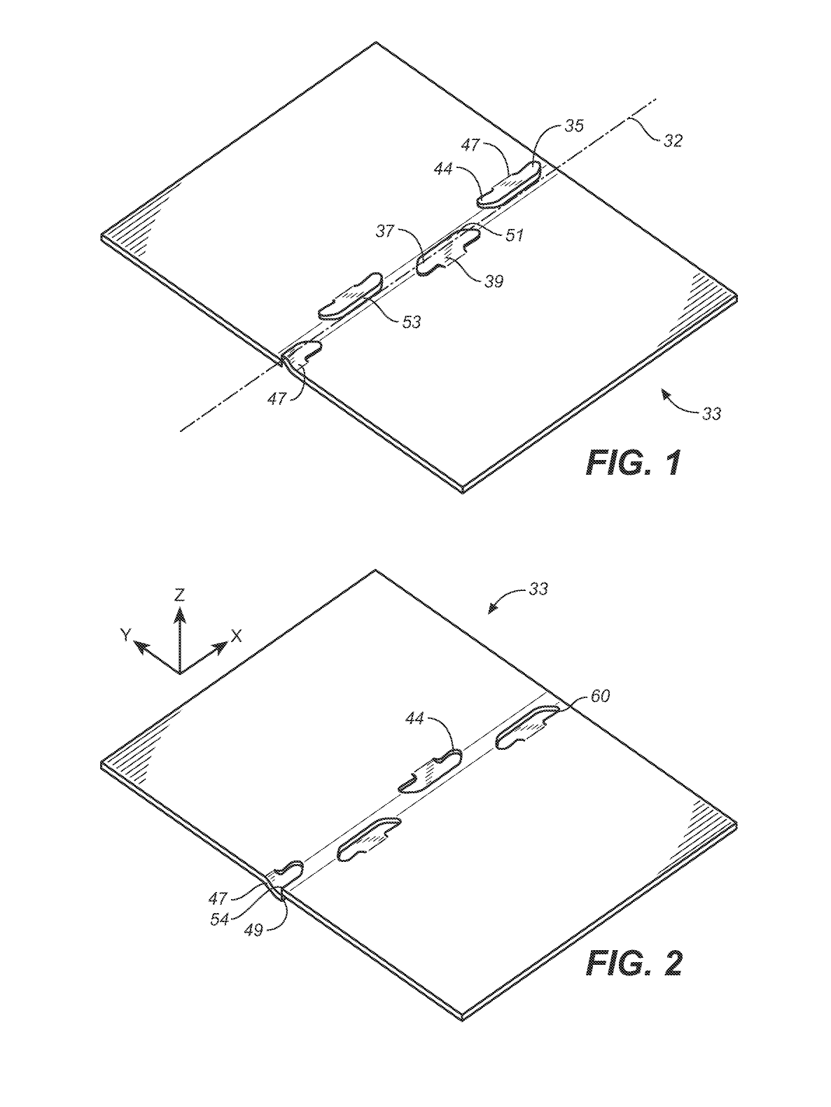

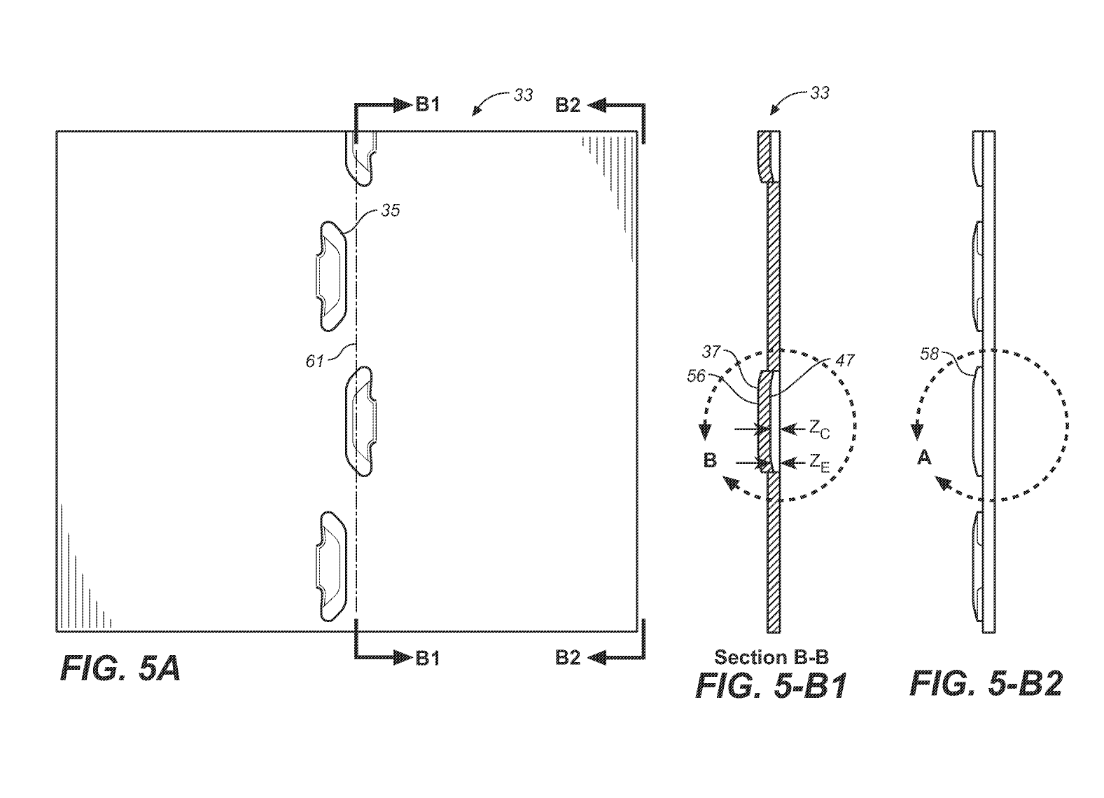

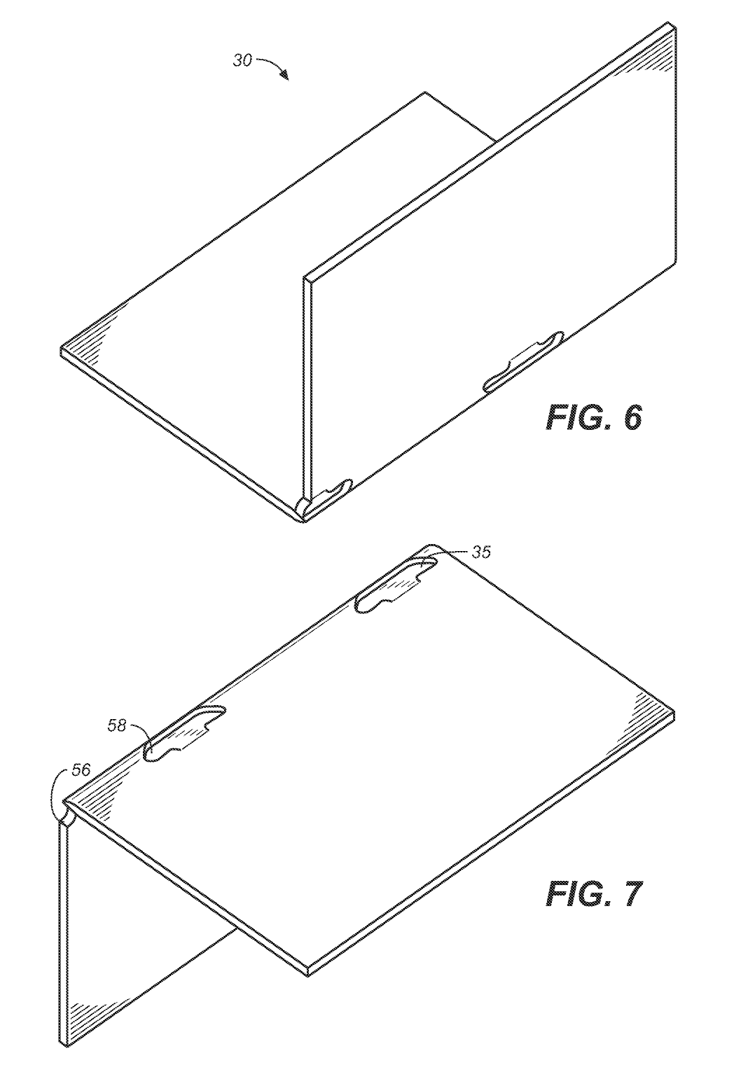

Turning now to the drawings, wherein like components are designated by like reference numerals throughout the various figures, FIGS. 6-7 illustrate a three-dimensional article 30 having a plurality of bend lines 32. The exemplary three-dimensional article is formed from a two-dimensional sheet of material 33 shown in FIGS. 1-5, which sheet that has a plurality of bend-controlling displacements, generally designated 35, populated along the bend lines.

Suitable materials for the sheet of material in accordance with the present invention include, but are not limited to, metals such as steel, carbon steel, alloy steel, stainless steel, galvanized steel, aluminum, titanium, metal composites and combinations thereof, and rigid plastics. In various embodiments, the sheet of material is a laminate structure. In various embodiments, the sheet of material is a material with relatively high-tensile strength or laminate material with relatively high-tensile strength. In various embodiments, the sheet of material is a non-compressible material. “Non-compressible” is to be understood as would be customarily understood in the art, especially the mechanical and materials science arts, and generally refers to materials that resist compressive forces. For example, “non-compressible material” generally excludes materials like cardboard and corrugated paper. In various embodiments, the sheet of material is formed of a relatively ductile material. In various embodiments, the sheet of material is a non-compressible material having high-tensile strength. “High-tensile strength” and “ductility” are used as would be understood by one skilled in the art. “High tensile strength” generally refers to strength in varying states of temper and annealing. In some cases, a high tensile strength material may refer to a relatively brittle material with high ultimate strength. “Ductility” and “ductile” or used interchangeably and generally refer to a material that provides some measured deformation under tensile strength. A “ductile material” is to be contrasted with highly brittle materials and materials that do not allow for significant permanent deformation. It will be understood by one skilled in the art that the macro, physical properties of the sheet during bending will be influenced, in part, by the thickness of the sheet and other properties. Therefore, “non-compressible,” “ductile,” and “high tensile strength” may also be understood based on such factors.

In various embodiments, the sheet of material is composed of T-6 aluminum and has a thickness of 2.5 mm. In various embodiments, the sheet of material is T-6 aluminum and the sheet thickness is in the range of about 0.6 mm to about 4 mm. In various embodiments, the sheet of material is steel and the thickness may one of 14 gauge, 15 gauge, 16 gauge, 17 gauge, 18 gauge, 19 gauge, and 20 gauge.

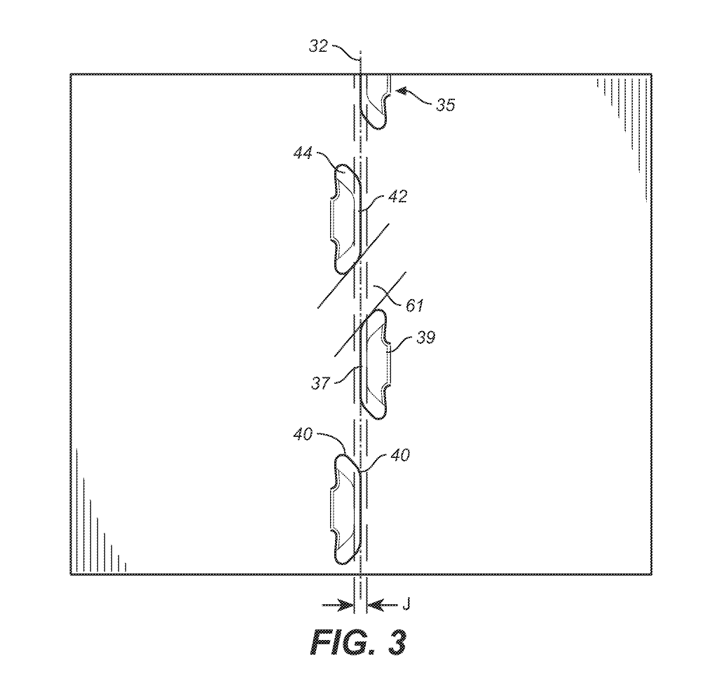

Referring to FIGS. 1-7, exemplary bend-controlling displacements 35 have a shape, in some aspects, similar to a mushroom with a cap and a stem. Each displacement 35 includes a displaced portion 37 and a stem portion 39. The displaced portion is defined by material displaced in a thickness direction of the sheet (e.g. into the page in FIG. 3). As will be described more fully below, a portion of the periphery of the displaced portion experiences shearing such that the displaced portion separates from the remainder of the sheet to form a sheared face 53. In turn, displaced portion 37 includes a periphery 40 corresponding to the sheared face. Periphery refers to both the peripheral edge of the displaced portion and the outer surface defining the peripheral edge.

Displaced portion 37 includes a central portion 42 extending along a bend line 32 and opposing end portions 44 at opposite ends of the central portion in a lateral direction. The periphery of the central portion and end portions define periphery 40 of displaced portion 37.

In an exemplary embodiment, periphery 46 has a non-uniform curve along its length in the x-y plane (see, e.g., FIG. 2). “Non-uniform” refers to the varying radius of curvature and/or nonlinearity of the periphery. As shown in FIGS. 1-2, for example, the periphery has at least seven different radii of curvature along its length. In various embodiments, the periphery along central portion 42 has a mild curved profile and a relatively small radius along end portions 44 with transitions in between. In various embodiments, the central portion periphery is at least about five times the thickness of the material. In an exemplary embodiment, periphery 40 along central portion 42 is substantially straight and parallel to bend line 32. In an exemplary embodiment, the end portions have a periphery defining a small-radius arc. In an exemplary embodiment, a portion of the periphery along the central portion is substantially parallel to the bend line and gradually transitions to a small-radius arc along the end portions.

In various embodiments, a portion of the periphery along the transition between central portion 42 and end portion 44 is substantially straight and at an obtuse angle to the bend line. In various embodiments, end portions of adjacent bend-controlling structures 35 on opposite sides of bend line 32 are positioned and configured to define a quadrilateral bending strap therebetween. As illustrated in FIG. 3, the periphery of the respective end portions define a bending strap wherein the sides are substantially straight in accordance with the straight periphery portions of ends 44.

All things equal, the material characteristics generally determine the onset of shearing. In the case of T-6 aluminum, for example, shearing begins when the material has been displaced about 0.45T or 45% of the thickness of the sheet. By contrast, mild steel can be displaced to a depth several orders larger before shearing begins unless a cutting edge is applied. Accordingly, each material type may have an associated critical shear depth.

In various embodiments, periphery 40 of displaced portion 37 along the bend line and end portions is displaced beyond a critical shear depth of the material thereby shearing the material. By contrast to laser cut slits, shearing caused by displacement of the material generally does not have clearly-defined start and stop points. Thus, in areas where the material is displaced about a sufficient depth to create shearing—critical shear depth—partial shearing may occur. In various embodiments, the transition between the displaced portion and remainder of the sheet is gradual thereby forming an area of partial shear between the edge of displaced portion 37 and the edge of stem portion 39.

The shearing of exemplary displaced portion 37 terminates in the region of stem portion 39. Sheared edge 49 thus extends along the bend line and around lateral ends of the displaced portion before terminating in a transition region between the end portions and the stem portion. Sheared edge refers to a fully-sheared portion of the sheet and does not include the partially-sheared transition.

During bending of the sheet, stress lines generally propagate along the fully-sheared edge 49 and continue in the direction of the end of the sheared edge. A partially-sheared edge may influence stress propagations but will do so to a lesser degree than a fully-sheared edge. Moreover, the sheared edge creates a shear gap through which stresses do not pass. From this standpoint, the sheared edge isolates displaced portion 37 from stresses in the remainder of the sheet.

The stem portion interconnects the displaced portion to a remainder of sheet 33. The interconnecting material may be formed with a large enough section of material to prevent cracking or breaking In various embodiments, the periphery edge turns around a respective end portion and then extends back towards the bend line in the transition to the stem portion. Such a configuration provides a smooth transition from the sheared edge to the stem portion while reducing the effective height (i.e. y-axis in FIG. 2) of the bend-controlling displacement.

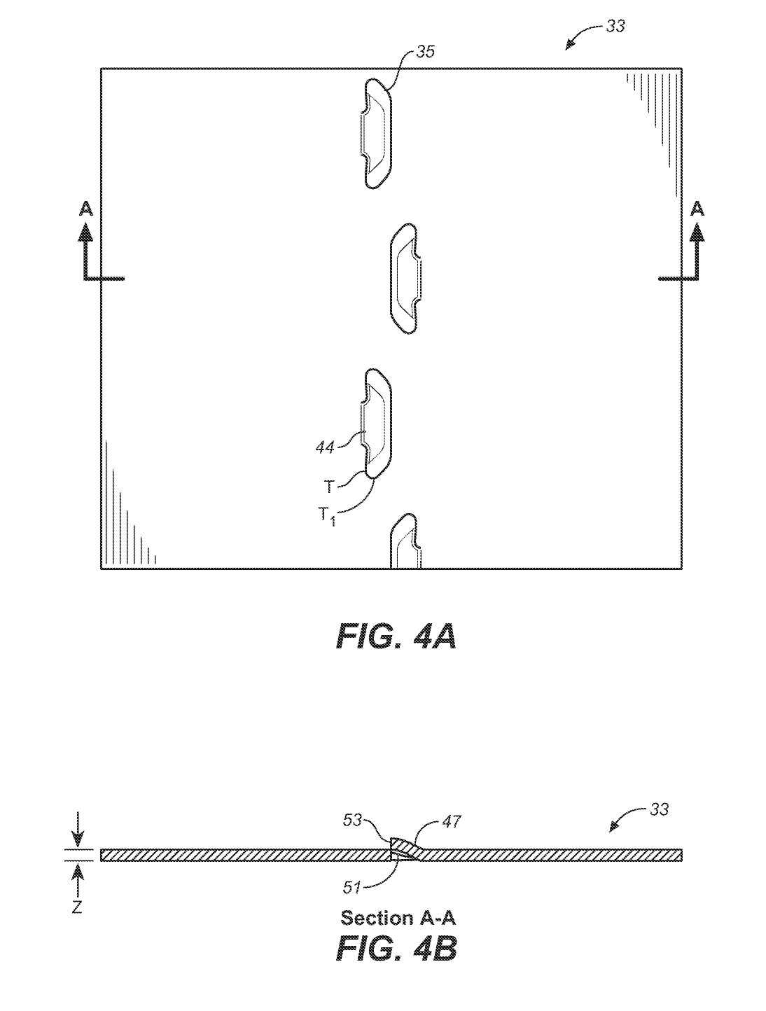

In an exemplary embodiment, the stem portion is defined by termini of the sheared face. “Termini” or “terminus” of a sheared face refers to point at which the sheared edge, or partially sheared edge, terminates with respect to material that is not sheared. Put another way, “termini of the sheared face” refers to the point at which shearing begins or ends. In various embodiments, the stem portion is located inwardly of central portion 42. In other words, the stem portion is narrower than the central portion and located within boundaries defined by the width of the central portion. In an exemplary embodiment, the terminus of shear—the region where full shearing stops—is past the ends of the displaced portion (see, e.g., T in FIG. 4-A). In various embodiments, the terminus of shearing is about 10° to about 20° inward of the ends of the displaced portion. In various embodiments, the terminus of shearing is at the outermost ends of the displaced portion (see, e.g., T₁ in FIG. 4-A). In this manner, stresses arising in the sheet are directed away from bending straps 61 and other working sections of the sheet that undergo stress during bending and loading of the resulting article. One will appreciate from the description herein, however, that the terminus of shearing may be located at various positions to adjust the behavior of the material.

Stem portion 39 interconnects displaced portion 37 to the remainder of the sheet along an interconnecting region 47. In various embodiments, the interconnecting region is substantially planar and at an angle relative to the plane of the sheet. In an exemplary embodiment, the interconnecting region extends at an angle between about 15° and about 20° from the plane of the sheet.

As discussed above, sheared face 53 of displacement 35 is formed at least in part by displacing material in the thickness direction of the sheet material. In the illustrated embodiment, the displacements are formed on alternate sides of the bend line. One will appreciate, however, that the bend-controlling displacements may also be formed on one side of the bend line, which in some instances may provide a more appealing visual appearance by hiding the displacements from view. If the load direction is known, the bend-controlling displacements may be positioned on a side of the bend line in opposition to the load direction.

Generally, exemplary displacement 35 is formed by a lance impacting the sheet of material and displacing at least a portion of the material corresponding to displaced portion 37. The material may be displaced or punched into an opposing cavity in a relatively conventional manner. The bend-controlling displacement thus formed includes displaced portion 37 at least partially below the plane defined by an adjacent surface of the remainder of the sheet of material (e.g., opposed sheet surface 54). An end of the displaced portion proximate the bend line is completely sheared such that a sheared edge 49 is at least displaced partially below a plane defined by the original sheet of material to create sheared face 53 (see, e.g., FIG. 2).

The shearing of the displacement creates a vertical displacement in the thickness direction of the sheet of material. The bend-controlling displacement defines an opposed face 51 opposite each sheared face 53 (see, e.g., FIG. 4-B). The displacement distance is referred to as “z-depth.”

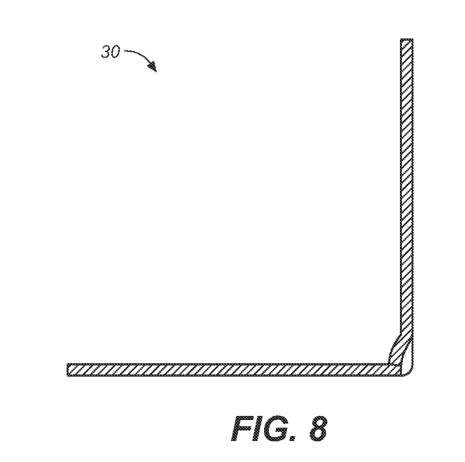

As illustrated, for example, in FIGS. 1-8, each displaced portion may have multiple associated z-depths. As will be understood by one skilled in the art, the variation in z-depth may be created with a non-planar lance or punch surface. In an exemplary embodiment, the maximum z-depth is at an end of displaced portion 42 along the bend line. In other words, the maximum z-depth is along the sheared face of central portion 42. In various embodiments, the minimum z-depth of the displaced portion (other than along the interconnecting region) is greater than the critical shear depth such that the entire displaced portion is sheared from the remainder of the sheet. In one embodiment, the minimum z-depth is about 65% to about 100% the thickness of the material.

A portion of periphery 40 of the bend-controlling displacement proximate the bend line defines sheared face 53 directed toward an opposed sheet surface, generally referred to as 54, in the sheet of material on an opposite side of the bend line. Opposed sheet surface herein refers to the panel or remainder of the sheet of material on an opposite side of the bend line from the sheared face of the bend-controlling displacement. Opposed face herein refers to the face surface at the end of the opposed sheet surface. The plurality of bend-controlling displacements 35 are formed in the sheet of material with sheared edge 49 extending along a respective sheared face 53. “Periphery” may refer to either the sheared edge or the sheared face extending along the displaced portion.

Generally, the vertical displacement will not be uniform because at least a portion of the displacement connects to the remainder of the sheet. Z-depth, however, refers to the displacement depth of a respective point of displaced portion 37. In various embodiments, the maximum z-depth is at least the thickness of the material and, and the outermost edges of the end portions are displaced a distance less than the thickness of material. Accordingly, the inclined portion forms a smooth transition from the displacement to the sheet.

In an exemplary embodiment, displaced portion 37 includes a planar zone 56 substantially parallel to the sheet of material and displaced to a z-depth. In various embodiments, the planar zone is part of central portion 42. In various embodiments, opposing ends 44 define inclined portions 58 extending from a point of greater z-depth. In various embodiments, end portions 44 have an incline angle between about 5° and about 10° relative to the surface of the sheet material. In an exemplary embodiment, the end portions do not connect to the sheet directly but instead connect through the central portion and stem portion.

In an exemplary embodiment, the displaced portion forms a “roof top” whereby portions of the displaced portion are displaced at different z-depths. In an exemplary embodiment, the displaced portion includes a planar zone at a maximum z-depth and inclined portions which are inclined downwardly from the planar zone towards opposing ends. “Roof topping” refers to forming a lance with a non-planar top configured to form a displacement with a zone at a maximum z-depth and other portions at a lower z-depth.

One will appreciate that the displaced portion may be formed at a single z-depth or with regions of varying z-depth and/or incline angles and other configurations. In one embodiment, the inclined portions are each displaced to a z-depth sufficient to cause at least partial shearing but are at a lower z-depth than the maximum z-depth. In one embodiment, the inclined portions are entirely displaced to a depth sufficient to cause full shearing around the entire edges (i.e. end portions 44). The displaced portion may also be formed with arcuate or curved surfaces. Generally, however, it is more expensive to create tools with such curved surfaces than angled planes.

Roof topping generally reduces the tonnage of the equipment used to form the displacements. In contrast to displacements requiring displacement of all or most of the material to the maximum z-depth, roof topping limits the area of maximum shearing. For example, with the exemplary displacement, the amount of shear required along the periphery of the end portions is less than that required along the end of the central portion. In other words, the material is only stamped to the maximum z-depth along a portion of the displacement (along the bend line in the exemplary embodiment).

The particular shape of the displacement plays a noteworthy role in controlling the behavior of the sheet during bending. For example, the curve of the central portion periphery in a plane parallel to the sheet plays a role in drawing opposed sheet surface 54 into engagement with sheared face 53. It has been found, for example, that a central portion periphery with a relatively large radius of curvature promotes elastic deformation of the opposing face and thus appears to promote the opposing face being pulled against the sheared face.

The radius of end portions 44 also plays a role in controlling the orientation of the sheared face relative to the opposed sheet surface. The end portions are a small radii arc, meaning, the end portions have a tight curvature. In various embodiments, the radii of curvature of the end portions are within an order of magnitude of the thickness of the sheet material. In an exemplary embodiment, the end portion radii of curvature is equal to about 1.6T (1.6 times the material thickness). The radius of curvature of the end portions and/or sheared edge also plays a role in controlling and directing stress risers in the sheet during bending.

In an exemplary embodiment, periphery 40 is curved substantially along its length. The arcuate profile of the periphery (in the x-y plane) generally promotes tension in the sheet along the bend line which pulls sheared edge 49 into engagement with opposing face 51. This tension or pre-loading decreases gaps along the bend line and generally serves to increase the strength of the bend line. If the tension is too high, however, gaps may form between the sheared edge and opposing face.

In an exemplary embodiment, the end portions have an arcuate profile similar to a curve along the central portion except that the radius of curvature of the end portions is substantially smaller. In practice, the radii of curvature may vary substantially and the shape and radii of curvature along the periphery may be modified independently.

The terminus of shearing also controls the behavior of the sheet during bending. As discussed above, bend-controlling displacement 35 includes a transition zone 60 between the sheared edge and the unsheared edge. In particular, the terminus of the shear is located along the interconnecting region 47. In various embodiments, the terminus of the shear is located inwardly of the end portions. It has been found that a smooth transition between end portions 44 and stem portion 39 causes stresses in the sheet during bending to follow the path of the periphery around the end portions. Referring to Example 1 below, this allows for directing stress concentrations away from bending straps 61. It has also been found that a smooth transition corresponds to improved contact of sheared face 53 with opposed surface 54 when the sheet is bent.

In an exemplary embodiment, the terminus of shear is within about 5° and about 15° of a longitudinal axis of the displacement along the end portions. One will appreciate, however, that the actual dimensions and location of transition 60 zone may vary tremendously depending upon the application. Moreover, the transition zone may have regional or localized characteristics but might not have distinct structural boundaries with respect to the end portions or might have different macro properties.

It has been further found that the shape and configuration of the displaced portion can control the amount and type of engagement of the sheared face and opposed sheet surface during and after bending. Each of the exemplary bend-controlling displacements is formed with a pair of bending straps 61 therebetween in the sheet of material which intersect bend line 32. The bend-controlling displacements are formed with bending straps on each end such that a respective sheared face 53 extends between the bending straps. These guidelines may be used to configure the displacement to increase contact and engagement of the sheared face with the opposed face and bending straps during/after bending.

In various embodiments, the bending straps are configured and positioned such that bending of the sheet of material subjects straps 61 to tension such that sheared face 53 closely abuts against opposed sheet surface 54 when the sheet of material is bent. In particular, as the two panels of the sheet on each side of the bend line are folded, the opposed sheet surface is pulled towards and conforms against the sheared face and sheared edge. It may be desirable to configure the bend-controlling displacements such that the bending straps pull over and against the outer ends of the displacements during bending. In this manner, these outer ends are substantially sealed and/or pre-loaded when the sheet of material is bent.

As shown, for example, in FIGS. 1-2, a gap may exist between the sheared edge of the displaced portion and the sheet. In the bent position, however, the sheared edge comes into contact with bending straps 61 and the opposed face. The central portion of the sheared edge is also in distributed contact with an opposed surface. Thus, the bending of the sheet seals the opposed surface to the sheared face when the sheet of material is bent. When the component and features of the displacement abut closely after bending, the seal becomes tighter and stronger.

Because the bending straps are pulled over the bend line as discussed above and in the aforementioned applications, the sheared edge along the central portion and inclined portions may be configured to align with the opposed face 51 of the sheet after bending. As discussed above, the displaced portion may include inclined portions to promote such alignment along the sheared edge. In an exemplary embodiment, inclined portions 58 form a curve sloping downward from a maximum z-depth of central portion 42. In an exemplary embodiment, the inclined portions and central portion create a bell or valley shape in the x-z plane. The curve and/or incline angle of the inclined portions are configured to match or correspond to the final position of bending straps 61 and opposed face 51.

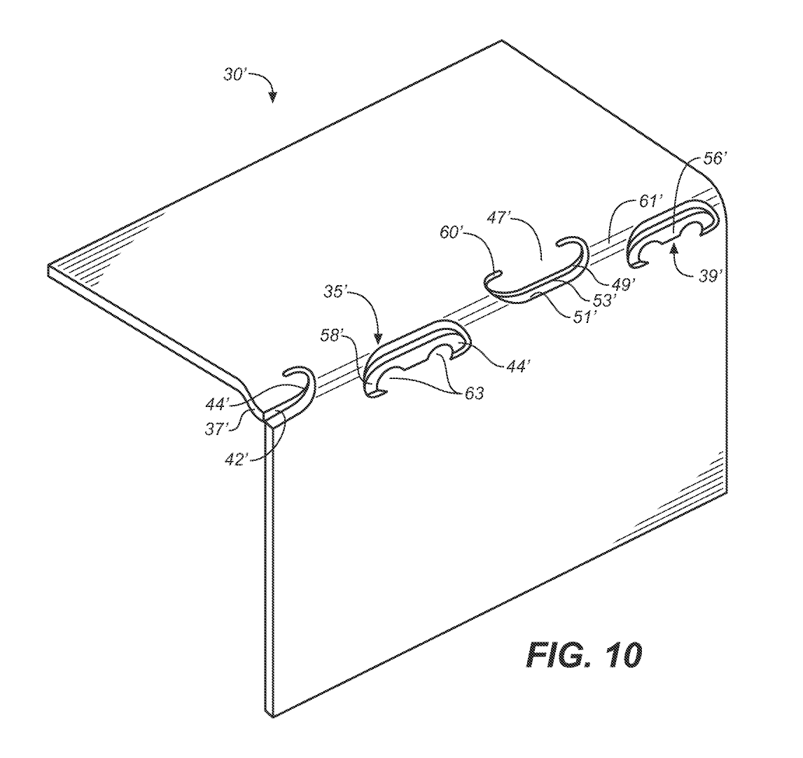

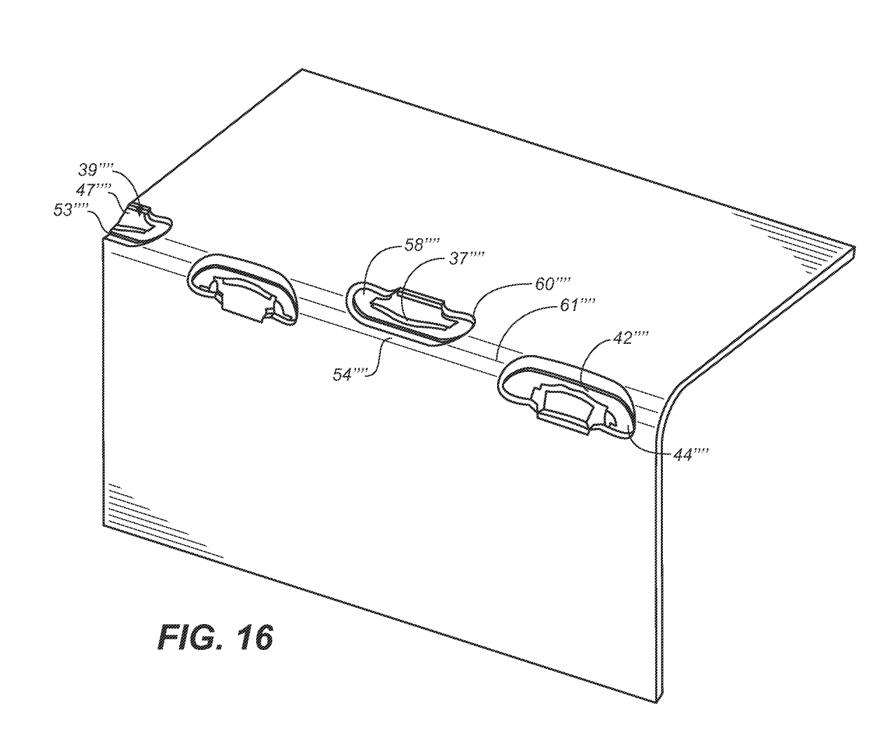

In various embodiments, inclined portions 58 are positioned and configured to correspond to or approximate the arcuate shape of the sheared edge 49 such that displaced portion 37 aligns with face 51 of opposed surface 54 after bending is complete. Accordingly, as shown, for example, in FIGS. 10 and 16, the opposed sheet surface and bending straps pull into engagement with the periphery of the displacement. With reference to FIG. 16, in one embodiment displaced portion 37′ is configured to align closely with opposed surface 54′″ to effectively seal the bend line for fluid resistance and/or greater strength. In the illustrated embodiment, the z-depth in the central portion is greater than the average z-depth along the end portions. In similar manner, the displaced portion may be configured and positioned for enhanced sealing or pre-loading after bending to reduce vibrations and natural harmonic forces.

As would be understood from the foregoing, the bend-controlling structures of the present invention have an increased contact area in comparison to existing bend-controlling structures. The increased contact area after bending increases the ability of the bend line to receive a load and provides a pleasing aesthetic with reduced gaps. Also, contact is generally flat which increases the ability to receive a load.

Turning back to FIGS. 1-8, in various embodiments, the sheared face is further configured to correspond to the sheared face with which it engages to modify the type of contact after bending. For example, in the illustrated example the sheared face is perpendicular to the plane of the sheet such that the opposed sheet surface lies flatly against the sheared face once the sheet is bent 90 degrees. Accordingly, loading along the bend line is transferred more directly into the displacement and into the remainder of the sheet on the other side of the bend line. By contrast, some of the force is directed into the displacement at an angle with existing bend-controlling structures.

In an exemplary embodiment, the sheet of material is T-6 aluminum and the z-depth is at least about 1.0 times the thickness of the material at a distant point of the displaced portion. Along the end portions, the z-depth is about 0.6 times the thickness of the material.

The method of forming the sheet of material in accordance with the present invention can now be described. Conventional tools such as a die (lance) and a cavity may be used. In some cases, the prepared sheet of material of the present invention may be formed simply by modifying a conventional lance and cavity by adjusting the ram depth and gap between the cavity area and lance area as described above. Further, it has been found that decreasing the footprint of the lance increases manufacturing flexibility. For example, decreasing the footprint of the lance makes laminating the sheet of material easier.

The location of shear termination and other characteristics may be adjusted by varying the configuration of tooling used to form the displacements as will be understood from the foregoing. In the case of a lance and cavity for example, the peripheral shape of the lance largely corresponds to the shape of displaced portion 37. The peripheral shape of the cavity largely corresponds to the shape of the sheared edge and interconnecting region. The edges of the lance and cavity thus form the shape of the bend-controlling displacement. By adjusting the lance and cavity shapes and the gaps as well as displacement distance, it is possible to adjust the location of shear termination.

In an exemplary embodiment, the bend-controlling displacements 35 are positioned along the bend line and define bending straps therebetween. The exemplary bending straps may be wider than those formed by the bend-controlling structures in the aforementioned applications. In various embodiments, the bend line is configured with a relatively greater number of bend-controlling structures which are shorter in lateral length, meaning from end-to-end.

With reference to FIG. 6-8, the prepared two-dimensional sheet 33 is easily bent into a three-dimensional article. The prepared sheet of material in accordance with the present invention may be bent by applying a force to sides of the sheet on opposite sides of the bend line. The force required for bending is reduced from conventional sheet bending such that, in some cases, the sheet of material may be bent without the use of tools or heavy equipment. The method of bending the sheet of material is described in greater detail in the aforementioned applications.

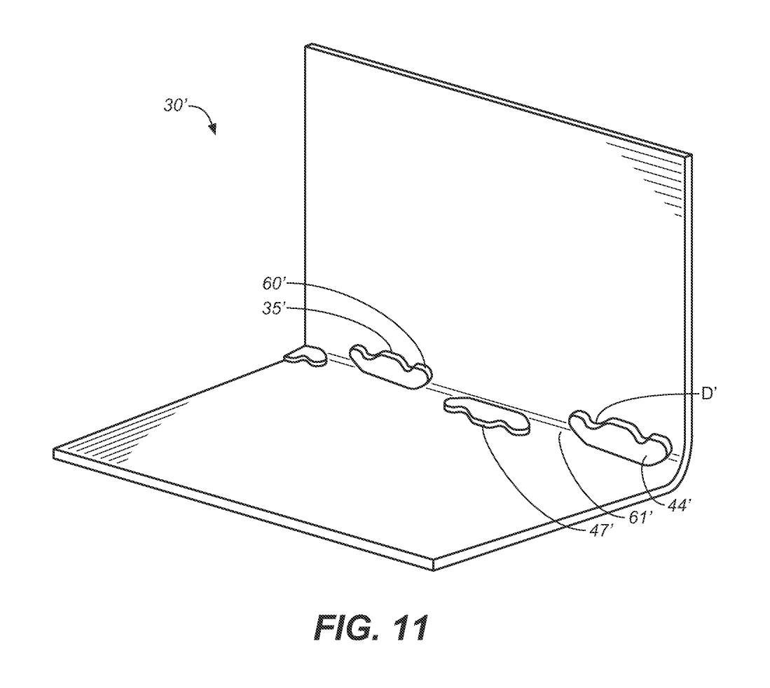

In various embodiments of the present invention, sheet 33′ is similar to sheet 33 described above but includes modified displacements 35′ as shown in FIGS. 10-11. Like reference numerals have been used to describe like components.

In various embodiments, interconnecting region 47′ is partially defined by one or more ribs 63 (e.g., shown in FIG. 10). In various embodiments, the interconnecting region is defined by opposing spherical ribs 63 located adjacent respective termini of the sheared face. As shown in FIG. 10, the exemplary rib effectively separate the terminus of the shearing from stem portion 39′. The ribs may thus be configured to control the termination point of stress risers in accordance with the above. One will appreciate that the shape and configuration of the interconnecting region may vary depending on the application.

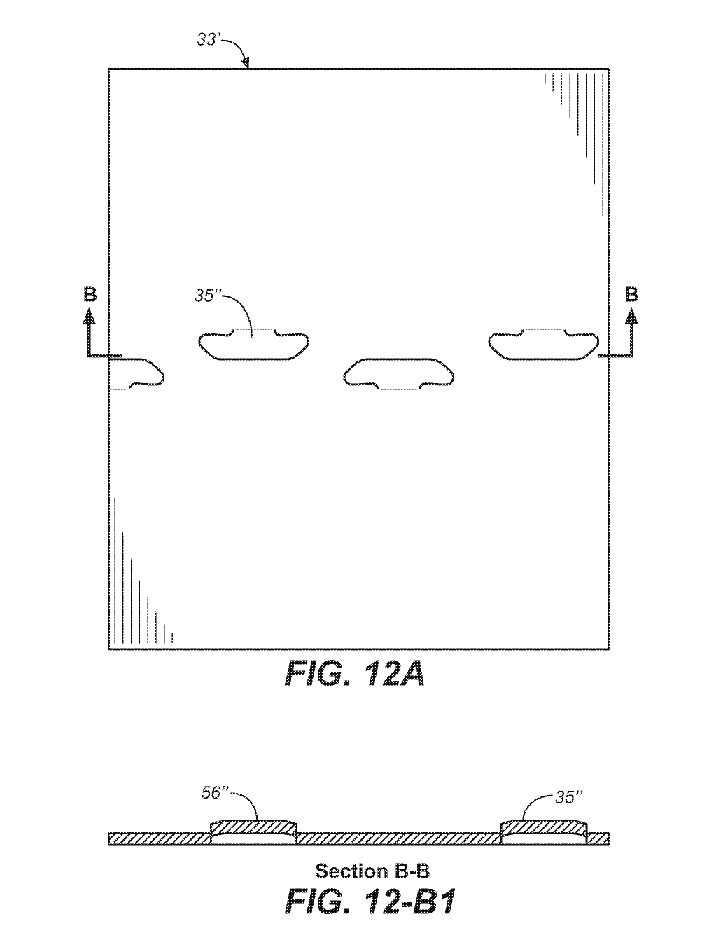

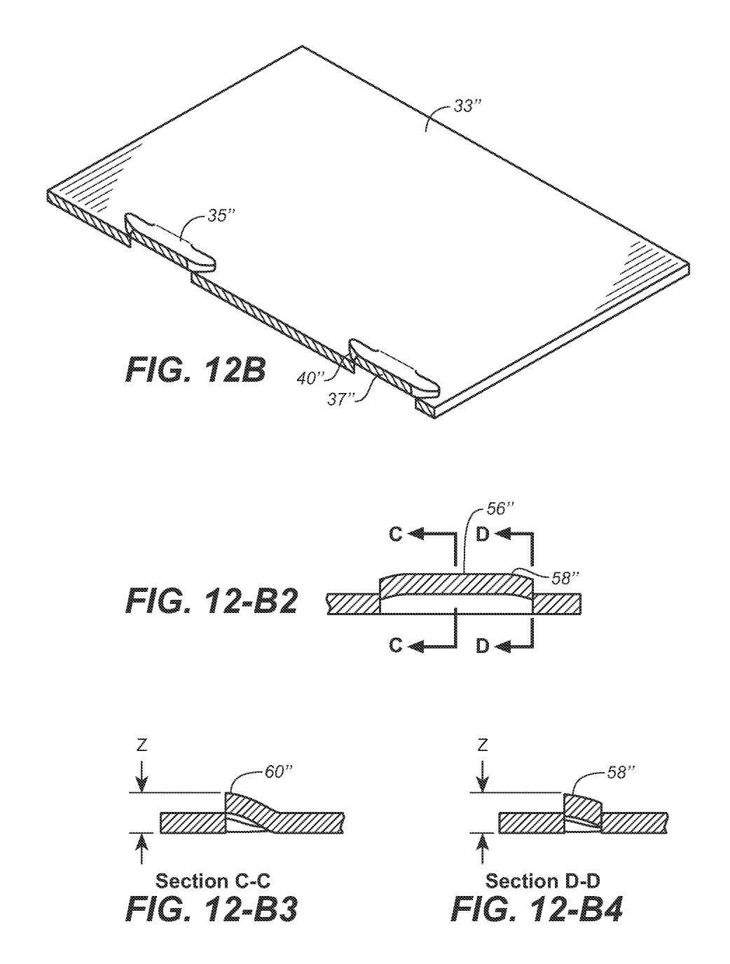

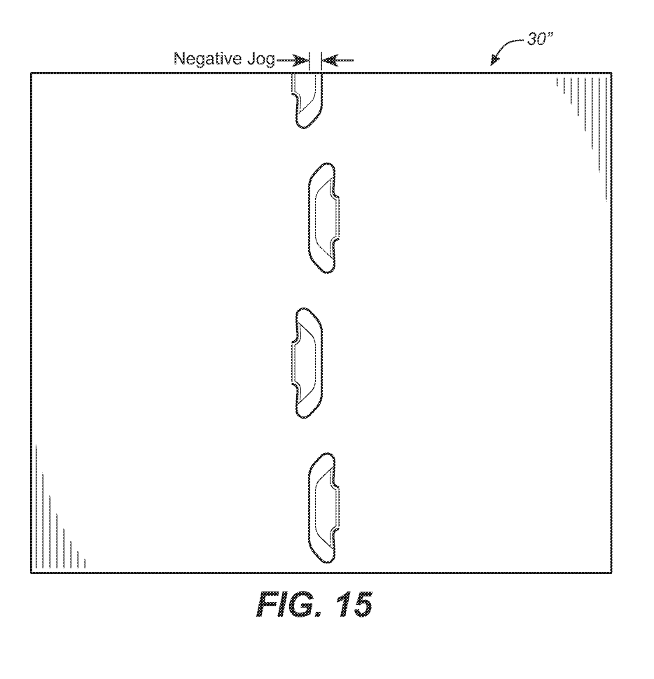

Turning to FIGS. 12-15, sheet of material 33″ is similar to sheet of material 33 except that various characteristics of the bend-controlling displacements have been modified.

FIG. 12 illustrates a sheet of material with zero jog distance and modified maximum z-depth. As shown in FIG. 12-B2, the maximum z-depth is less than the material thickness of the sheet. Referring to FIGS. 12-B3 and 12-B4, the displaced portion has a substantially flat shape by contrast to exemplary sheet 33. The central portion is at a maximum z-depth, and the end portions slope down towards the plane of the sheet. In the illustrated embodiment, the end portions have a z-depth of about 0.5 times the material thickness.

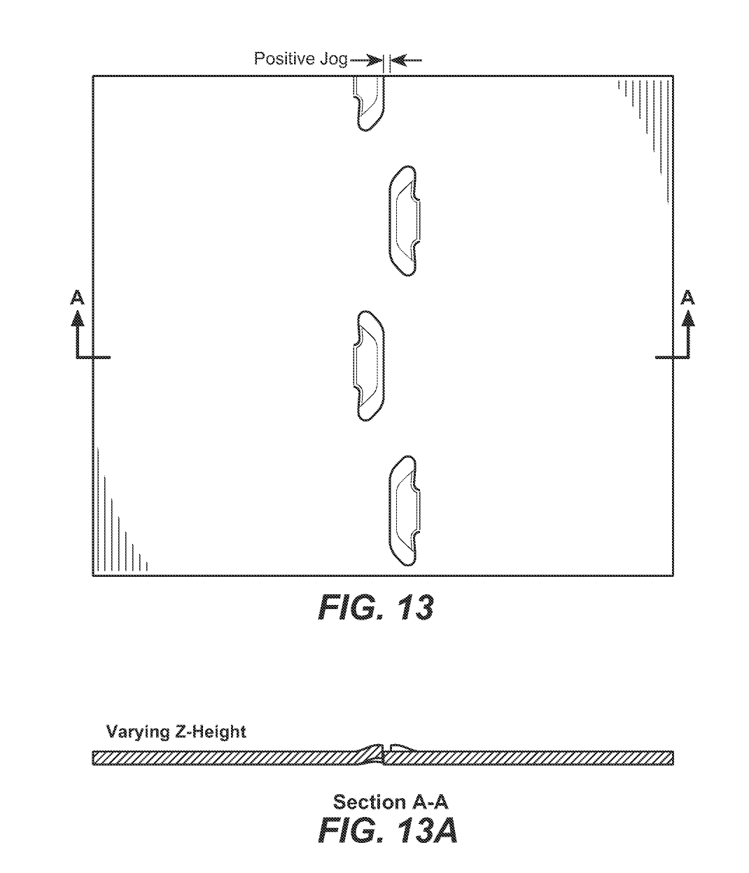

FIGS. 13-15 illustrate bend-controlling displacements on opposite sides of a bend line with zero jog distance. “Jog distance” refers to the lateral distance between a leading end of one displacement adjacent the bend line and an end of another displacement on an opposite side of the bend line. In various embodiments, the jog distance is less than zero such that there is an overlap between displacements on opposite sides of the bend line (see, e.g., “J” in FIG. 3). It has been found that preparing the sheet of material with a negative jog distance increases edge-to-surface pressure after bending which effectively pre-loads the bend-controlling displacements thereby increasing the strength and stability of the bend line. One will appreciate, however, that the jog distance may be varied and can be negative, zero, or positive.

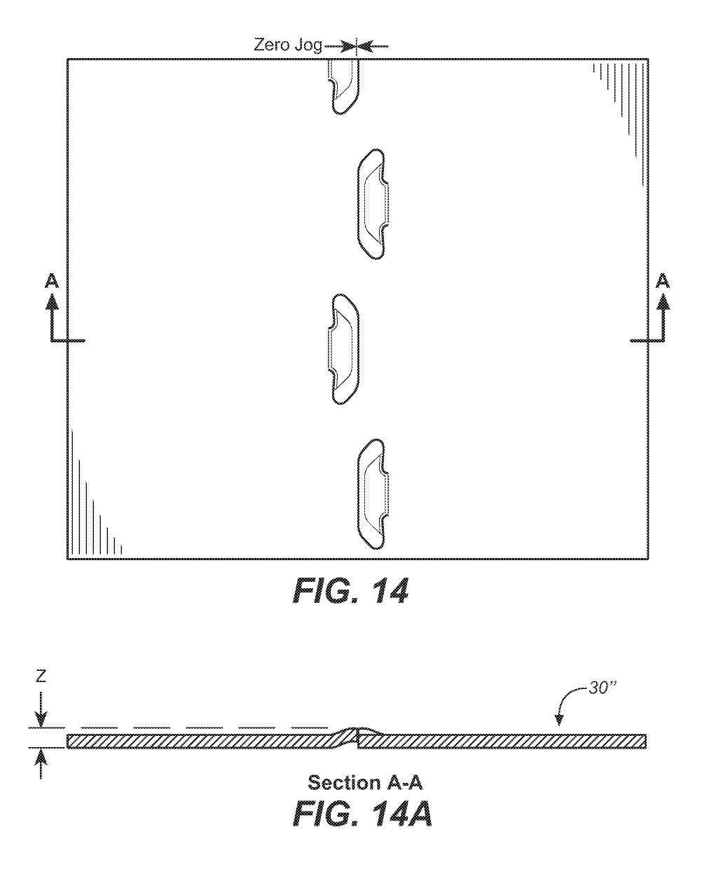

Although the jog distance may be zero (i.e. distant ends of displacements each lie along the bend line as shown in FIGS. 12 and 14), it has been found that warping and waves in the material may begin to develop during bending in the primary planes of the sheet as jog distance approaches zero. Jog distance also positively affects pulling of the straps against the displacement to provide for increased load capacity.

Finite Element Analysis Example 1

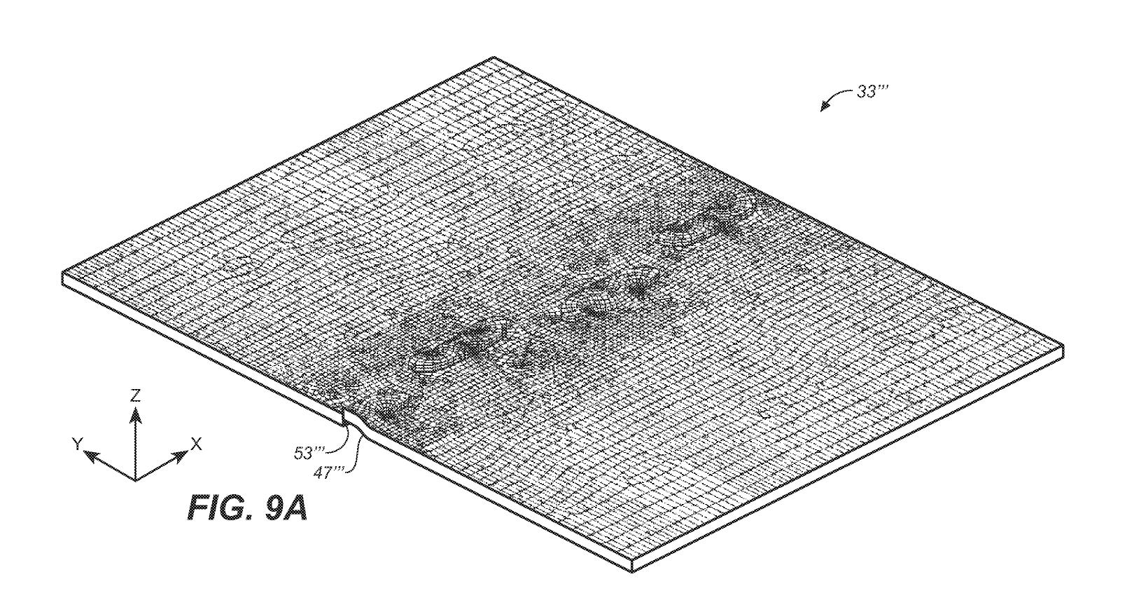

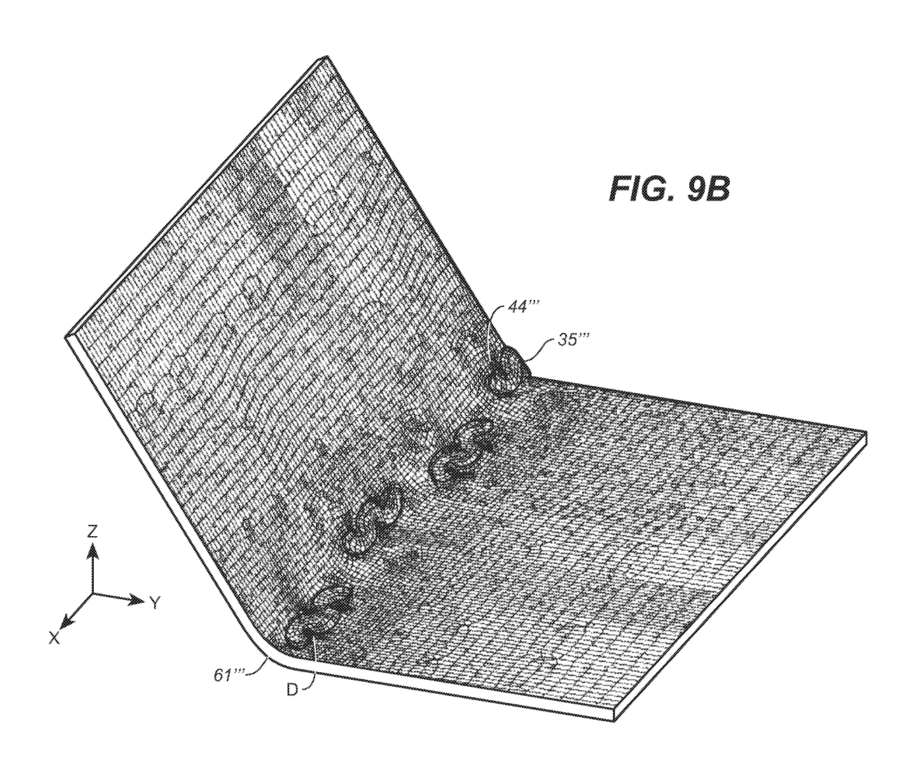

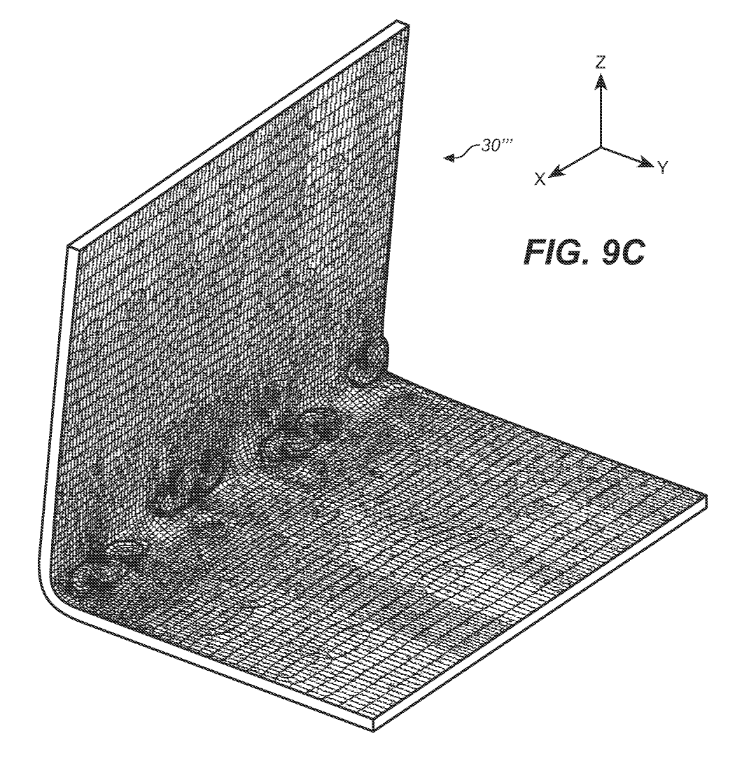

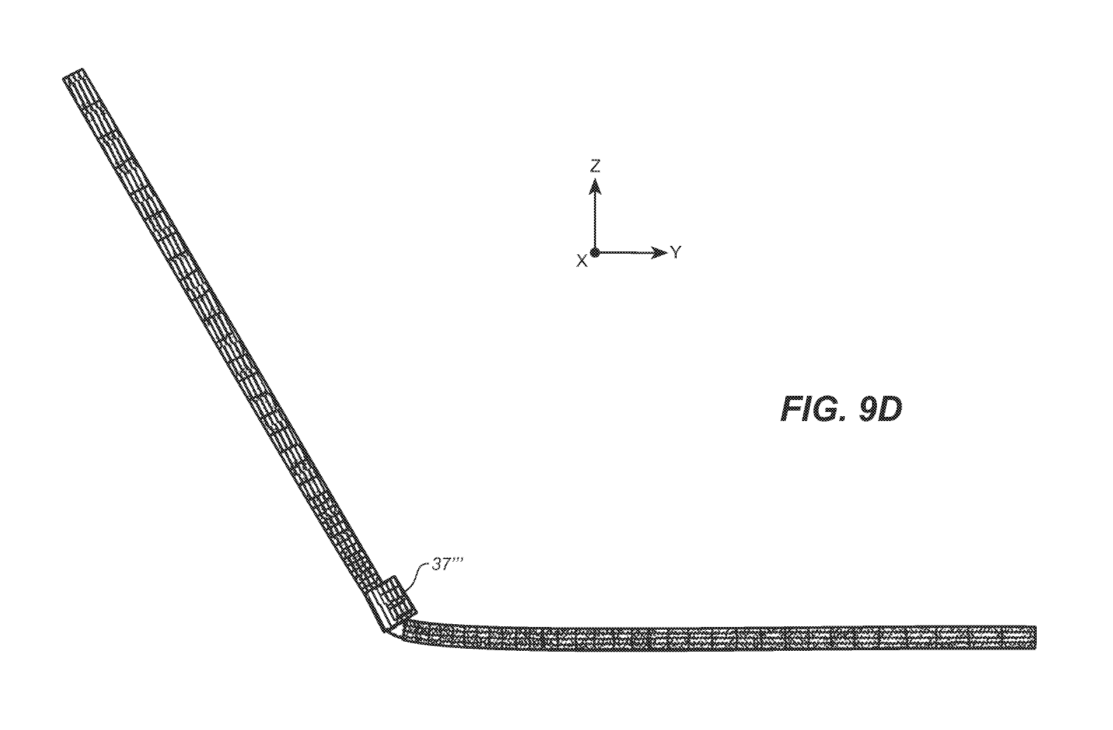

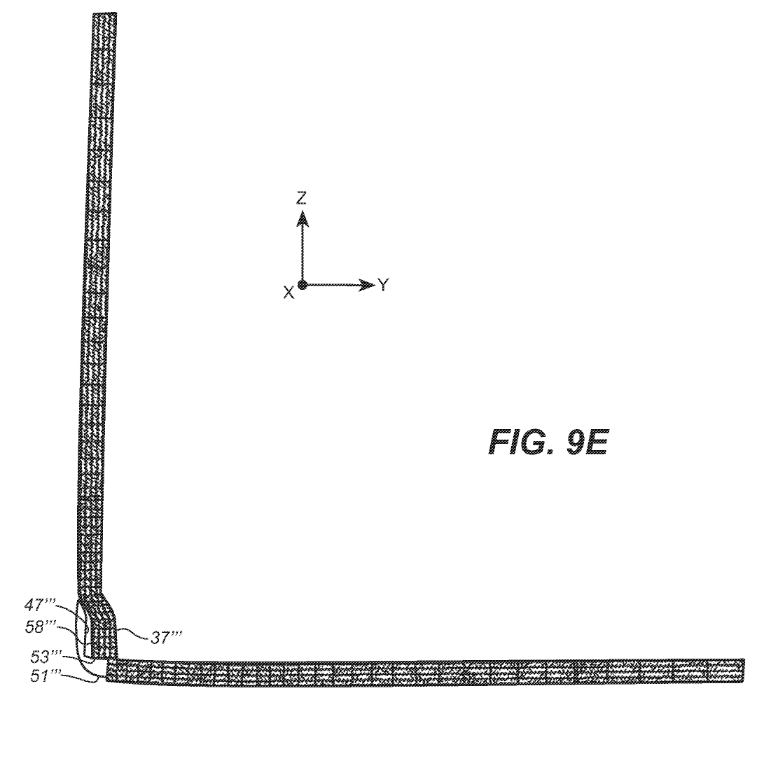

Turning back to FIG. 9, a finite element analysis (FEA) rendering of a sheet of material modeled on sheet 33 is shown. Like reference numerals have been used to describe like components of sheet 33′ and sheet 33.

Sheet 33′″ is formed with bend-controlling displacements 35′″ similar to bend-controlling displacements 35. As shown in FIG. 9, the formation of the displacements in the sheet creates stress concentrations in an around the connection between displaced portion 37′″ and stem 39′″. The concentrations are particularly acute in a region where the end portions tuck back in toward the stem and shear terminates.

During bending, the FEA model illustrated that stress risers occur along the intersection between bending straps 61′″ and end portions 44′″ (see FIG. 9-B). After bending, the stress concentrations are accumulated in the region below the end portions where shear terminates. Accordingly, it appears that the bend-controlling displacements in accordance with the present invention direct stress concentrations away from the bending straps central portion. It was further found that stresses tend to move around the end portions and do not encounter stress risers associated with shear termination. Rather, the stresses may encounter a “dead zone” (see, e.g., “D” in FIGS. 9-C and 11) and continue through the system. Thus, stresses are less likely to compound and accumulate in the sheet of material during bend and loading. In this way the bend-controlling structures of the present invention direct stresses from shearing and bending away from high-stress concentration areas. Consequently, fractures from bending stresses are less likely to occur in a region that will significantly affect bending and performance of the resulting three-dimensional article.

The analysis above confirms that the ratio of displacement length in a lateral direction (L/T), displacement height in a longitudinal direction (h/T), z-depth (z/T), and other features to material thickness play a role in controlling stress concentrations. It was further found that such characteristics appear to scale up uniformly such that the behavior largely remains the same as thickness and other features are scaled up uniformly. The above analysis further confirmed the role of the radius of curvature of the end portions, the incline angles, and the other features in controlling stress risers.

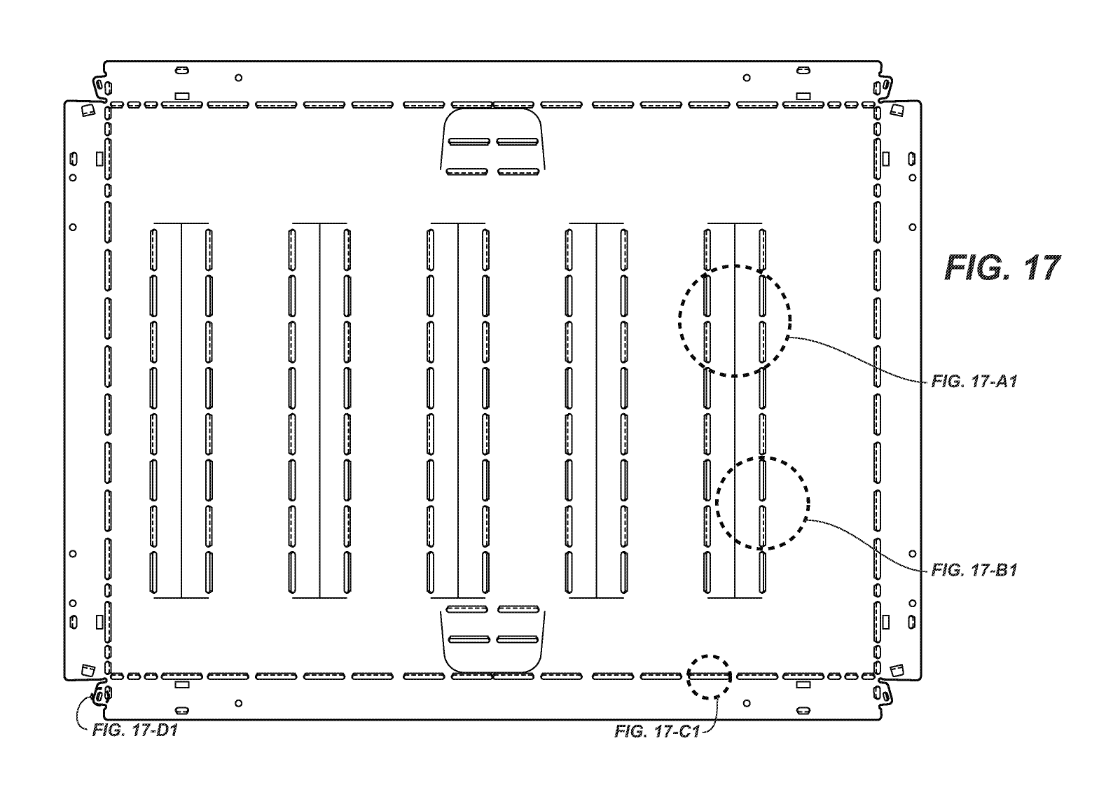

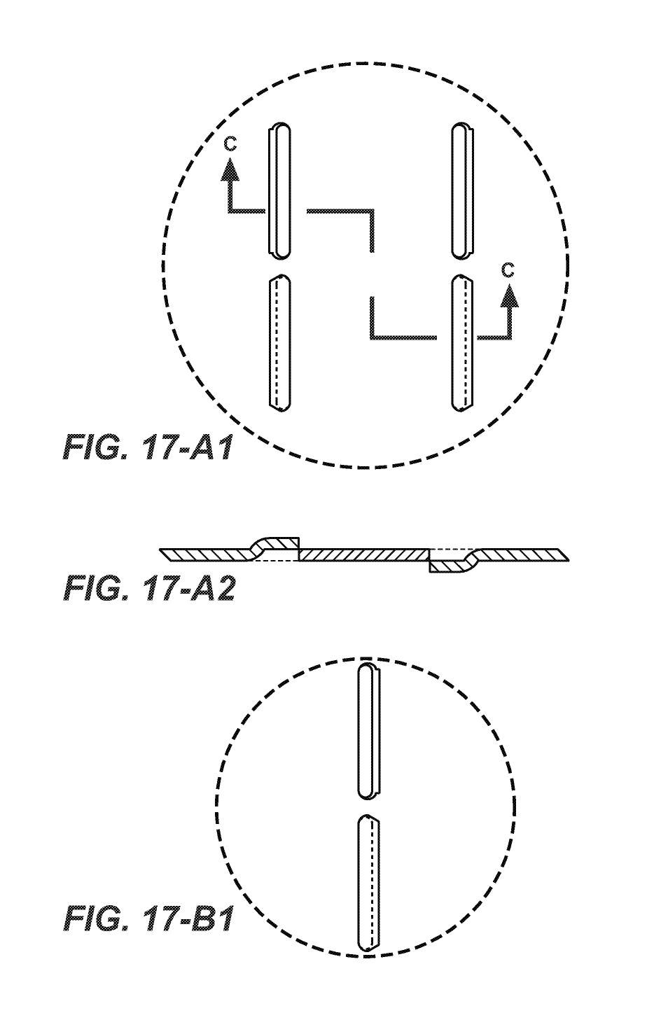

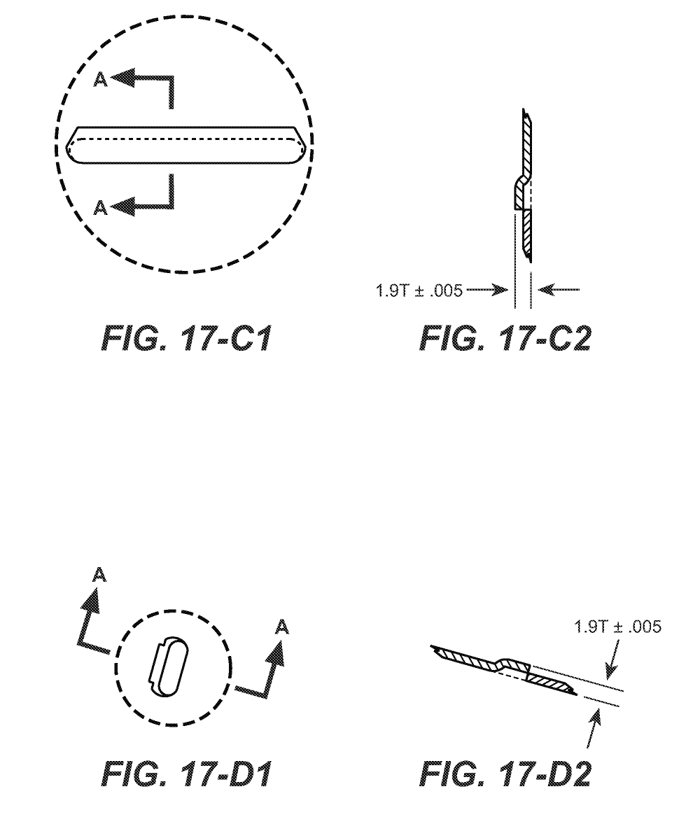

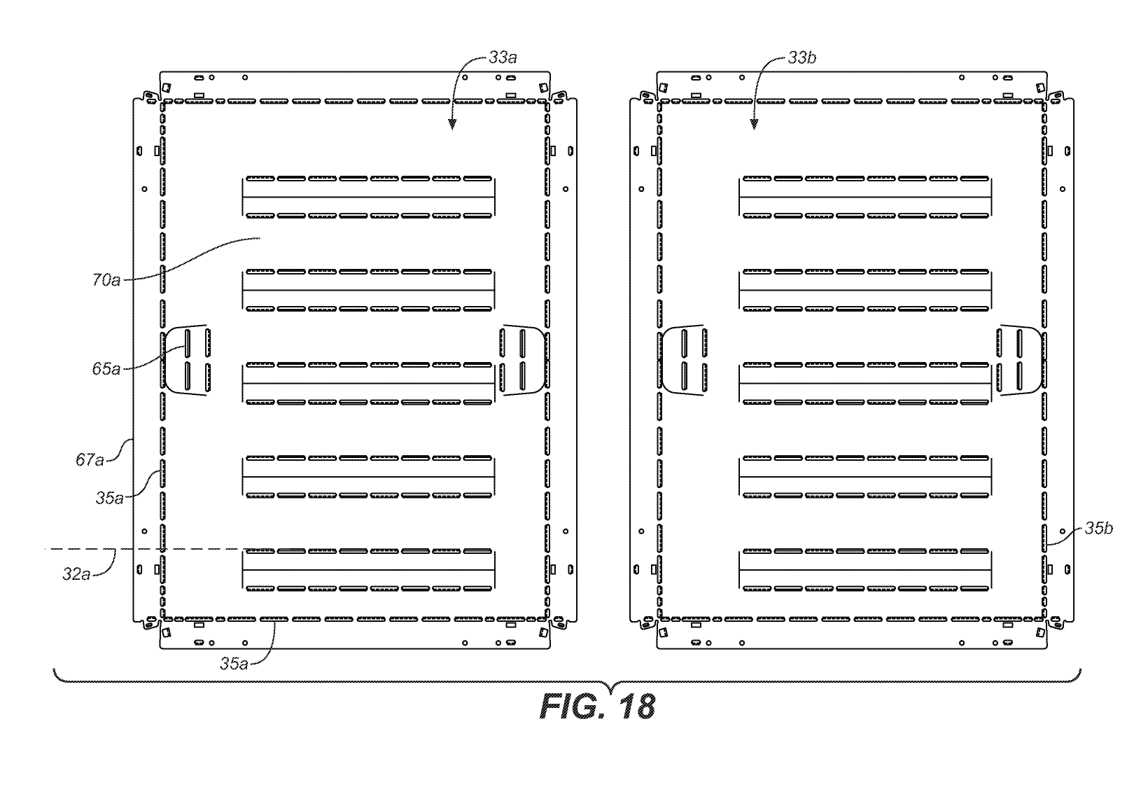

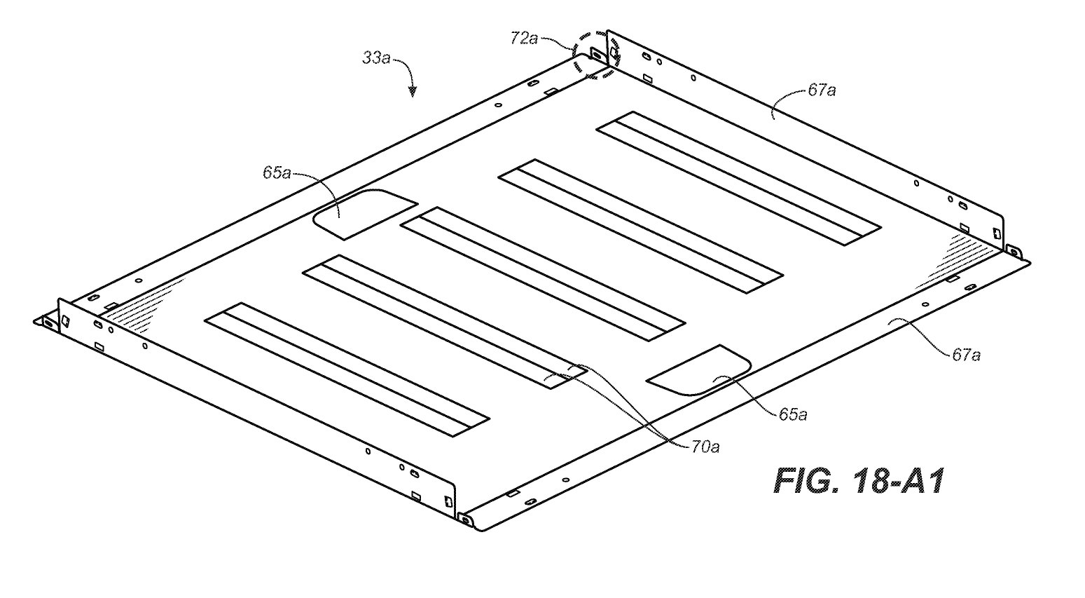

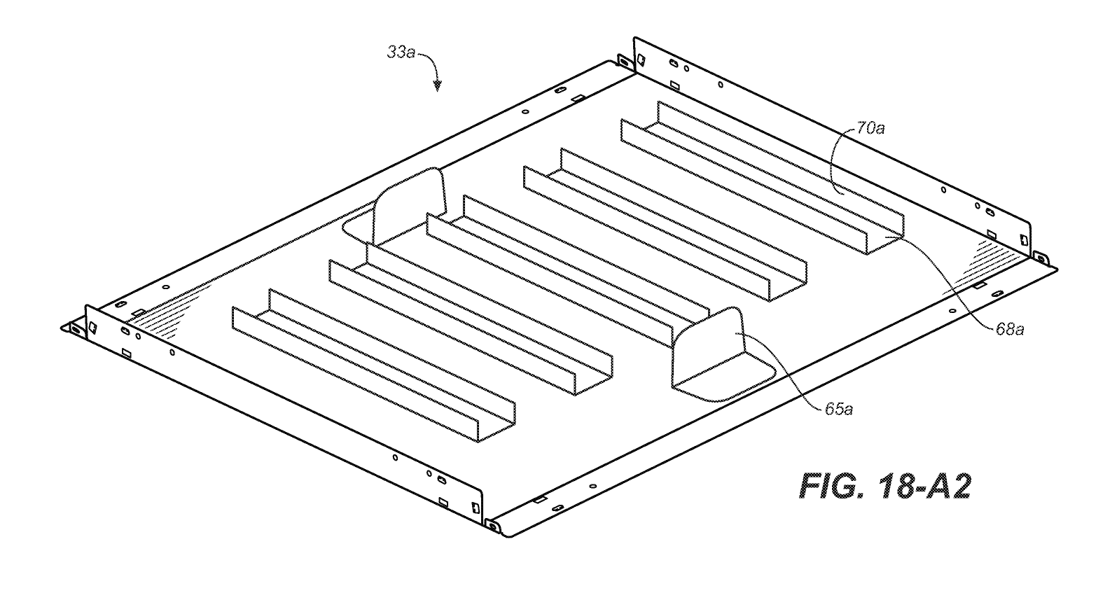

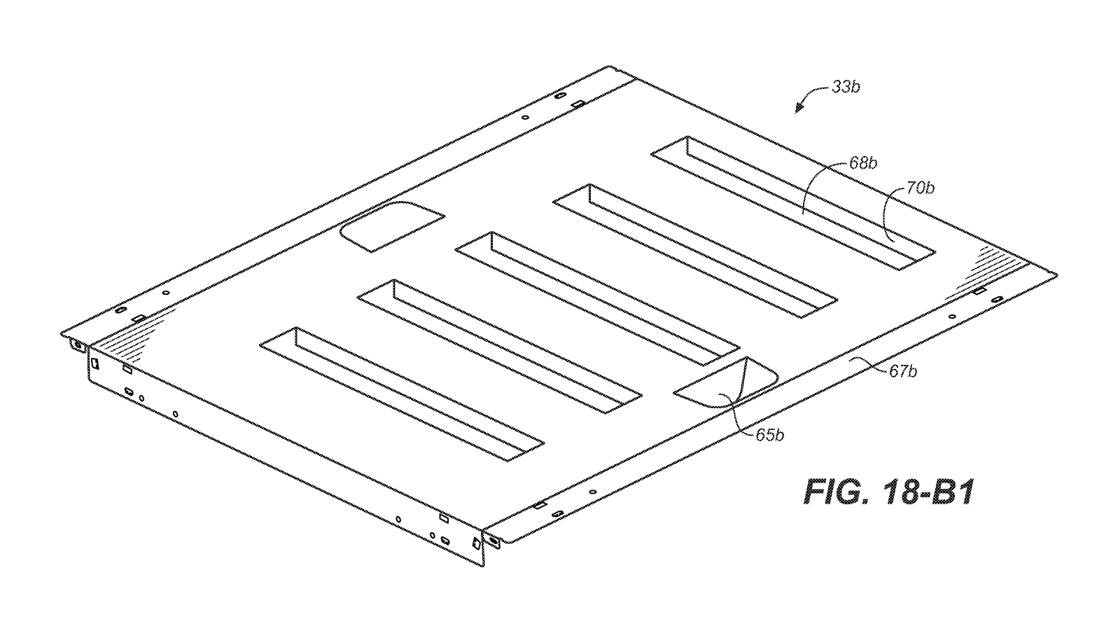

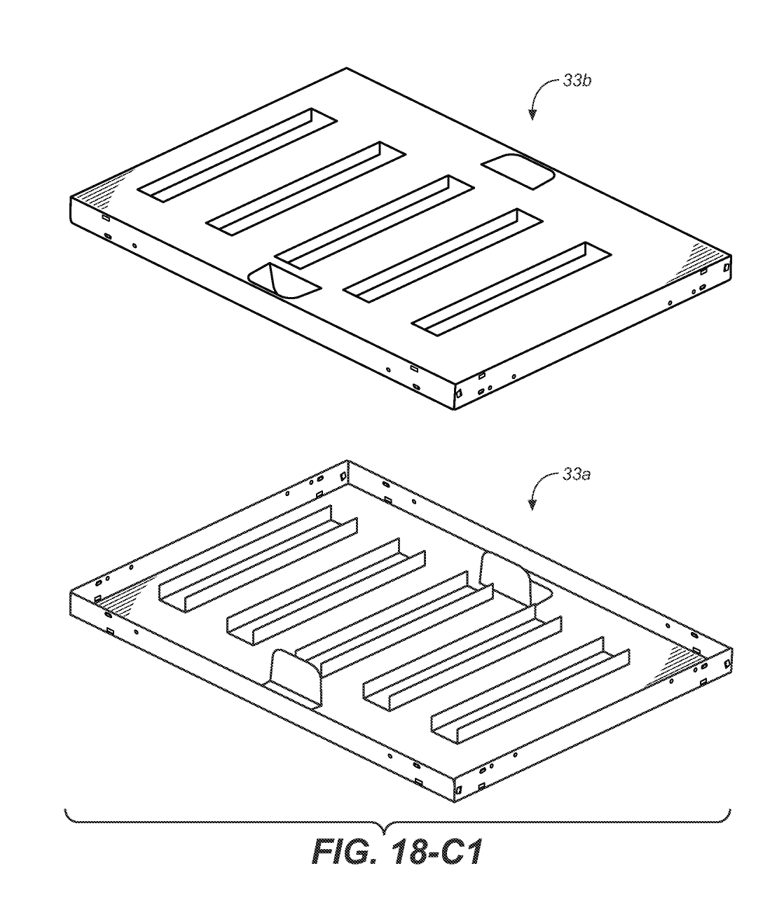

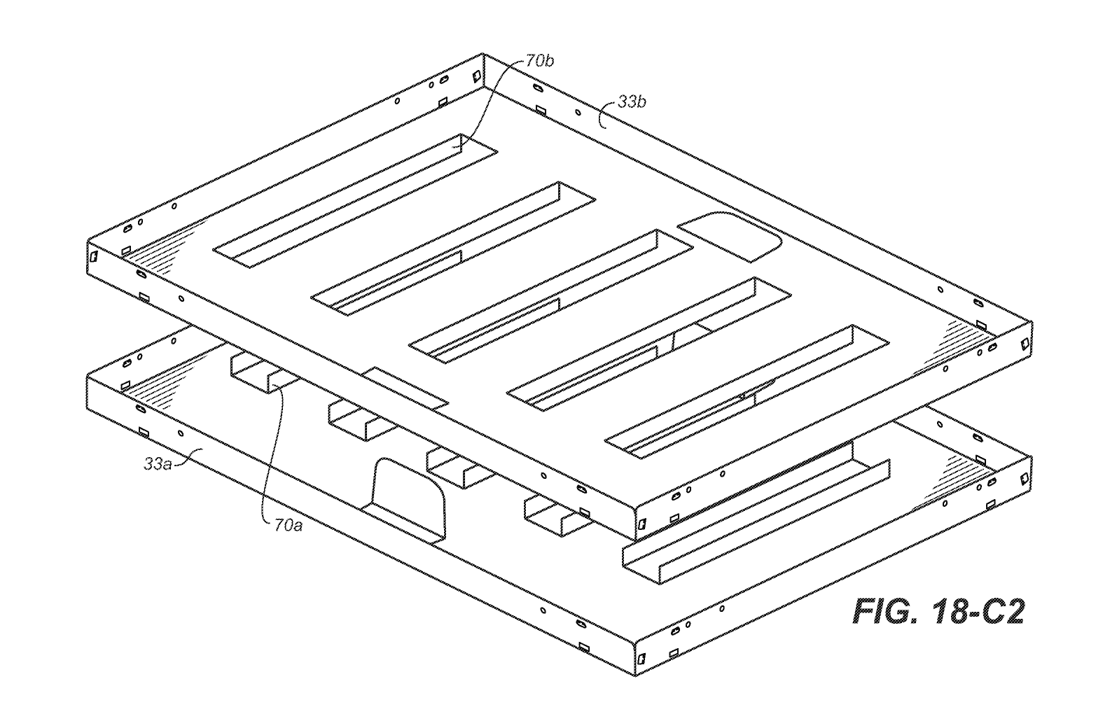

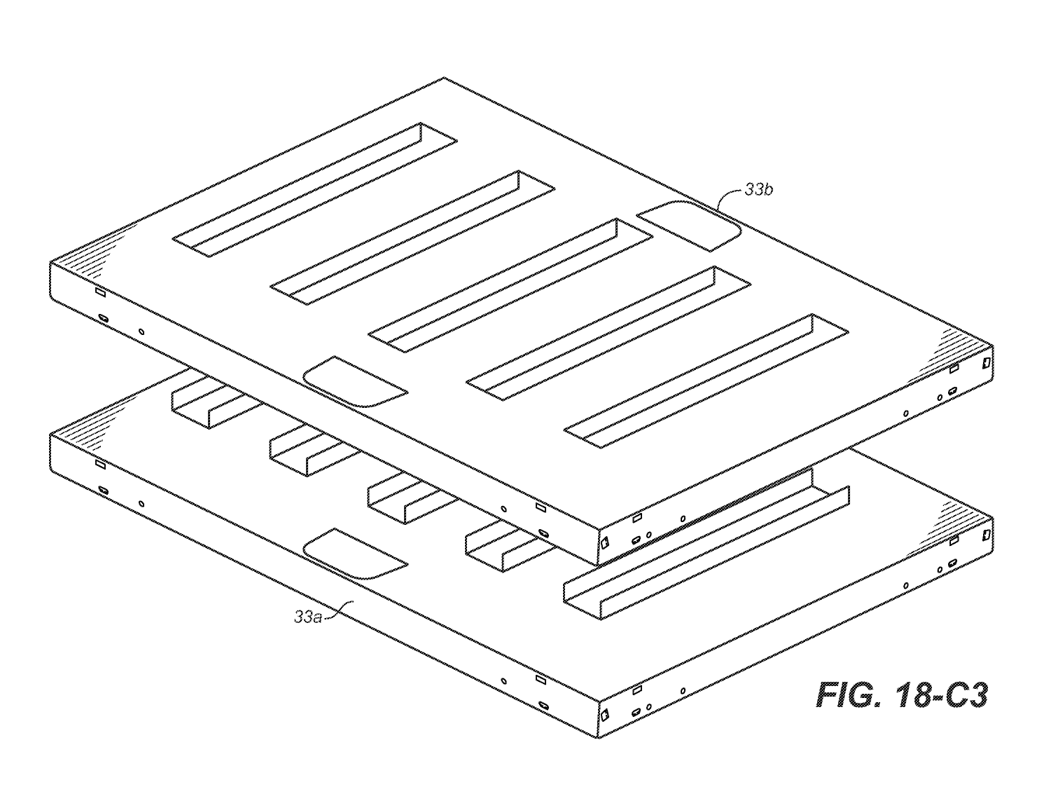

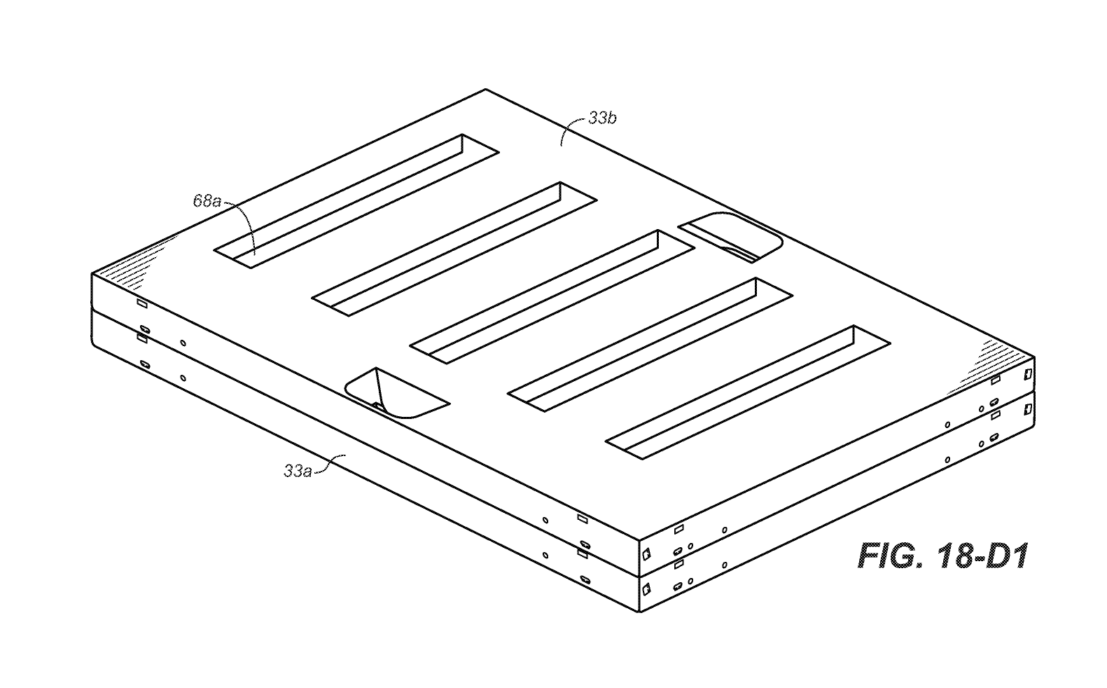

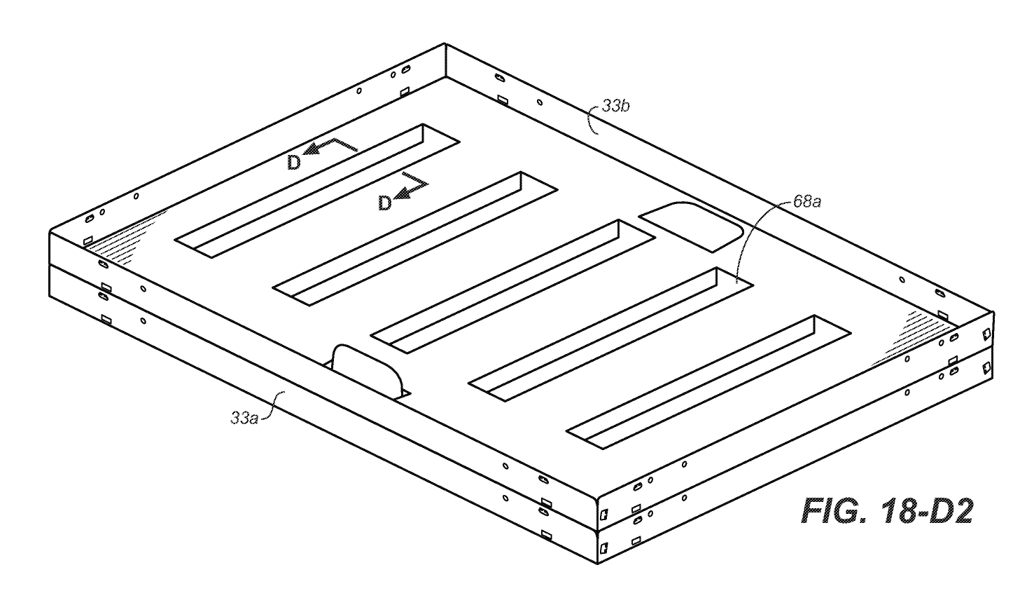

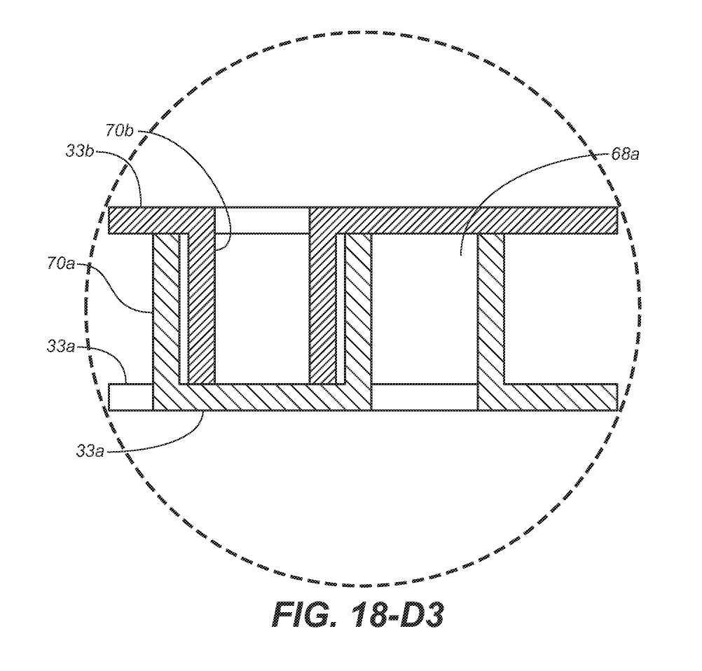

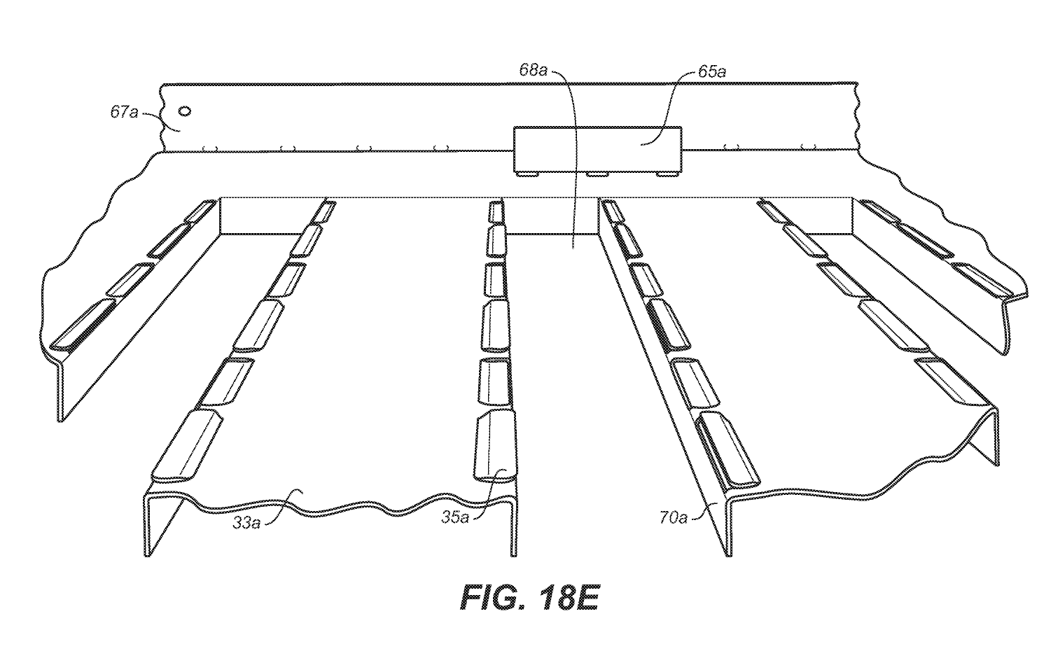

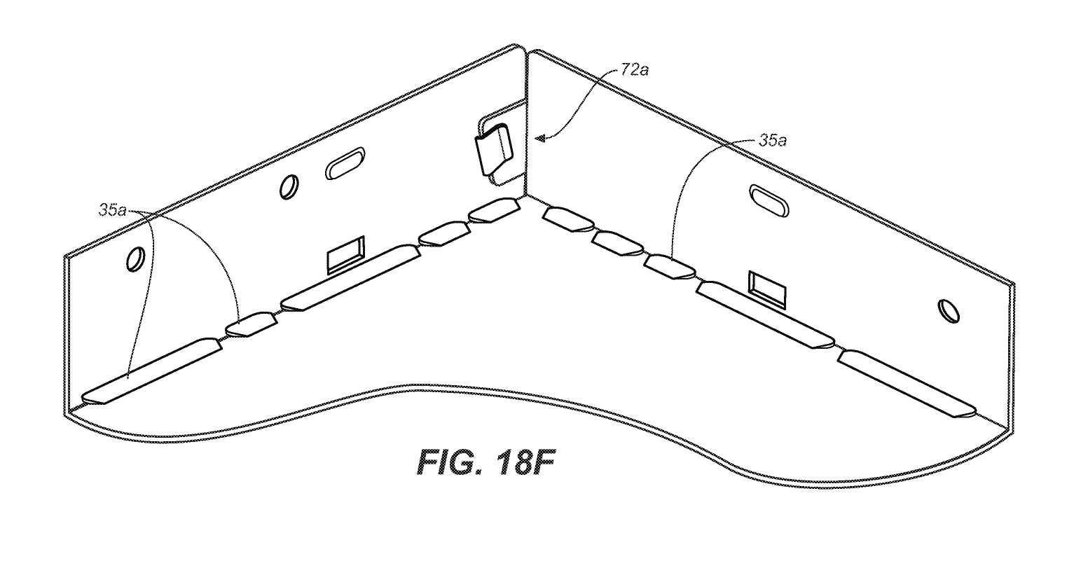

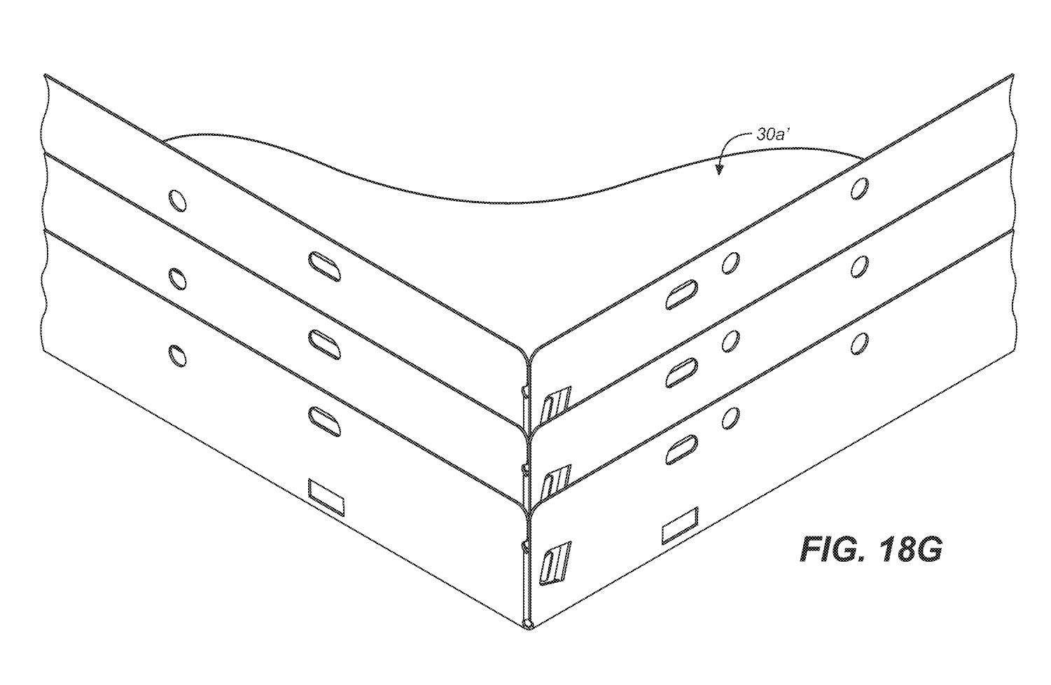

Turning now to FIGS. 17-18, a three-dimensional article 30a similar to structure 30 is shown. Like reference numerals have been used to describe like components of sheet 33a and sheet 33.

The exemplary article 30a is a heat shield intended for an exemplary oven cooking range and is formed from two sheets of material 33a, 33b. In various embodiments, the sheet is has a 24 gauge thickness or about 0.021 inch thickness. In various embodiments, the sheet is aluminum 5053. The sheets of material are prepared for bending along bend lines 32a defined by bend-controlling displacements 35a. The bend-controlling displacements 35a are similar to bend-controlling displacements 35 in various respects except that bend-controlling displacements 35a are configured for bi-directional precision folding. Although exemplary bend-controlling displacements 35a are formed by punching with a simple lance have one flat punching surface, one will appreciate that the displacements may be configured in other manner, for example, similar to bend-controlling displacements 35. In various embodiments, the sheets are formed of high tensile strength metal and at least one of the displacements includes a displaced portion displaced from the sheet of material in a thickness direction defined by a sheared face, the displaced portion further including a central portion extending along the bend line and opposing end portions at opposite ends of the central portion; and a stem portion interconnecting the displaced portion to the remainder of the sheet of material, wherein the stem portion is located inwardly of the end portions and defined by opposing termini of the sheared face.

The exemplary sheets are mirror one another, but one will appreciate that they need not be similar or identical. In various embodiments, two sheets are provided which are substantially or essentially identical. By “substantially identical” it is meant that the sheets differ from each other only in ways that do not affect the bending behavior of the sheets or resulting structure significantly. In various embodiments, the substantially identical sheets are mirror images of each other. The exemplary sheets of FIG. 18 are substantially identical with the same layout and general dimensions. “Substantially identical bend lines” refers to bend lines configured to effectuate functionally identical bending processes. One will appreciate that the bend line and bend-controlling structures may be modified in accordance with the principles described above and in the above-mentioned patent and patent applications.

In the exemplary embodiment, article 30a is a heat shield formed from two identical sheets 33a, 33b. The sheets have identical outer dimensions and bend lines. One will appreciate from the foregoing that the constraining design factors may be based on the application for which the resulting, bent article is intended. In this case, the sheet dimensions are based on the space into which the heat shield 30a is to be positioned. The bend lines of the exemplary sheets define knock-out tabs 65a, peripheral flanges 67a, venting slots 68a, and other features. As described above, each sheet may be prepared with bend lines in various positions and configurations to define a variety of features in-the-flat.

The bi-directional fold lines 32a in accordance with the present invention enable the use of identical sheets 33a, 33b in lieu of differently-designed sheets to form different, bent, three-dimensional products. “Bi-directional” folding refers to precision bending in either direction along the bend line. In other words, one panel of the sheet may be rotated with respect to an adjacent panel on the other side of the bend line in clockwise or counterclockwise directions. Put another way, the sheet may be bent in the thickness direction—orthogonal to the plane of the sheet—in either direction.

The bi-directional fold lines 32a include bend-controlling displacements 35a which are displaced in the thickness direction of the sheet. The displacing of the material works the material and causes shearing along the periphery of the displacement. The resulting displacement includes a sheared face 53a.

By contrast to fold lines 32, fold lines 32a includes a displacement 35a displaced in one thickness direction and another displacement 35a displaced in an opposite thickness direction. “Opposite thickness direction” refers to an opposite direction along about an axis of the bend line in the thickness of the sheet, or in other words, perpendicular to the plane of the sheet along the bend line. “Opposite thickness direction” is to be contrasted with “opposite sides of the bend line” which refers to the same side of the sheet but on the other side of or across the bend line in the same plane. As shown, for example, in FIG. 17-A2, some of the exemplary displacements are punched upwardly and some of the displacements are punched downwardly.

The identical configuration of exemplary sheets 33a, 33b provides several advantages. As will be described below, such a configuration allows the sheets to be stacked upon one another to form the product. One will also appreciate that several advantages are realized by reducing the article to a combination of two similar or identical parts versus two entirely different folded sheets. At the least, the use of identical parts significantly reduces manufacturing costs and complexity. By contrast, conventional heat shields, for example, are formed from three or more parts that are manufactured by three unique manufacturing processes. Even with existing sheet metal bending techniques, the bend lines are configured for bending in one pre-determined direction. In other words, although sheet 33a appears identical to sheet 33b, conventional techniques would require two different sheets with bend lines having bend-controlling structures with reverse bend line configurations. The bend lines of each sheet would be designed for bending in the different (reverse) directions. Using conventional techniques, a bend line in sheet 33a would thus have displacements all punched downward whereas the same bend line in sheet 33b would have displacements all punched upward.

By contrast, the bend line in accordance with the present invention allows for bi-directional precision folding in more than one direction. Such folding is enabled by the use of bend-controlling displacements along the bend line configured for precision bending in multiple directions. Specifically, one or more of the bend-controlling displacements is formed and configured for precision bending in one direction. One or more of the bend-controlling displacements along the same bend line is in turn formed and configured for precision bending in a different direction. Thus, precise bending may be effectuated in either direction.

One will appreciate that the principles of the present invention have broader application. For example, one or more of the bend-controlling structures may be configured for other unique process, such as to form a stop to bending or to provide overlapped support of the sheared faces during different stages of the bending in accordance with the above-mentioned Related Patents and Applications.

A schematic view of sheets 33a, 33b illustrating details of the sheets is illustrated in FIGS. 17-17D2. As will be apparent from the exemplary sheets, the bend-controlling displacements in the sheet are configured to precisely control bending along specified bend lines. At least a portion of the plurality of the exemplary displacements are displaced in the thickness direction by a distance equal to or less than about one material thickness of the sheet. In various embodiments, the displacement distance (z-depth) is 0.9 times the thickness of the sheet. In various embodiments, the maximum displacement distance is along a central portion of the displacement and end portions of the displacement are inclined towards the remaining material. In various embodiments, the central portion of the displacements includes a flat zone.

Along the bend line defining each peripheral flange 67a, the bend-controlling displacements 35a are longer in the middle of the bend line than near the corners. The displacements in the exemplary sheet are varied to control the strength and bending characteristics in localized portions of the sheet. The corners have relatively short displacements and bending straps therebetween to provide a stronger resulting bend line. In the exemplary sheet 33a, successive displacements are formed on the same side of the bend line (best seen in FIG. 18-E). The same-sided displacements form half-straps which bend over the bend line during bending. Such half-straps are described in greater detail in the above-referenced U.S. Patent Publication No. 20080098787. In the exemplary sheet 33a, successive displacements are formed on alternating sides of the sheet of material. In other words, one displacement is displaced downwardly on one side of the sheet and a successive displacement is displaced upwardly on an opposite side of the sheet.

Turning to FIGS. 18 to 18-D2, the method for assembling exemplary article 30a in accordance with the present invention will now be described. Sheets 33a, 33b are formed in-the-flat with features related to the intended resulting features of the article to be formed. As shown in FIG. 18, exemplary sheet 33a is essentially identical to 33b. All the bend lines in the exemplary sheets are configured for bi-directional precision folding; so, the sheets do not have a distinct top or bottom by design.

FIGS. 18-A1 to 18-A2 illustrate folding of sheet 33a, and FIG. 18-B1 illustrates folding of sheet 33b. The sheets are bent along the fold lines as described in more detail in the above-referenced patents and patent applications. Although the exemplary sheets are identical, the sheets are generally folded in opposite thickness directions along the bi-directional fold lines. Vent flanges 70a defining vent slots 68a of sheet 33a are folded upward (see FIG. 18-A2) whereas the corresponding flanges in sheet 33b are folded downward (see FIG. 18-B1). Likewise, corresponding tabs 65a are folded in different thickness directions. The sheets are rotated 180 degrees relative to one another about an axis parallel to the thickness direction. Because the bend lines defining the vent flanges are not symmetrically positioned on the sheets, the bent vent flanges on one sheet will be offset from the other sheet after rotation (see FIG. 18-C3).

Next, the folded sheets are positioned together. Bent sheet 33b is positioned on top of bent sheet 33a. Sheet 33b is turned so the folded portions of sheet 33b align with the folded portions of sheet 33a (see FIGS. 18-C2 and 18-C3) as discussed above. The bent portions of sheet 33a align with sheet 33b. As best seen in FIGS. 18-D1 to 18-E, the folded portions of the lower sheet 33a align with the holes formed by the folding of corresponding folded portions in 33b. Thus, tabs 65a in sheet 33a are positioned adjacent to respective tabs in sheet 33b. Similarly, the folded portions forming vent slots 68a are positioned adjacent one another. The length of the tabs 65a may be used to create a spacing or offset between sheet 33a and sheet 33b by contact of the tabs with the unfolded material on the other sheet. In various embodiments, at least one of the sheets is provided with an offset tab dimensioned and configured to control the spacing between the two or more stacked sheets. In various embodiments, fasteners are provided on one of the sheets to interlock with the other sheet and set the relative of positions of one with the other. The exemplary sheets include spring clip fastener structures 72a to affix the folded peripheral flanges into position.

The overlap of vent flanges 70a and the corresponding vent flanges in the second sheet form a double-thickness wall to vent slots 68a (see FIG. 18-D3). As shown in FIGS. 18-D1 and 18-D2, corresponding vent slots are formed on each side of the formed heat shield. In the exemplary heat shield, the vent slots form an opening area of about 70 square-inches. In various embodiments, the vent slot area is at least about 30 square-inches. One will appreciate that the opening area can be adjusted easily by selectively folding the vent flanges. For example, the maximum opening may be obtained by folding all the vent flanges. A lesser amount may be achieved by folding less than all the vent flanges. The total opening range may also be easily adjusted by modifying the sheet in-the-flat.

The folded, stacked sheets of material are subsequently fastened together to form a unitary structure 30a. In the exemplary embodiment, bent sheets 33a, 33b are fastened by interference fit. In particular, the matching dimensions and bend line positions create a close-fitting arrangement between the two sheets that forms a natural interference fit. The sheets are further fastened by the overlapping respective flanges, tabs, and other features. One will appreciate that other fastener technology may be used to fasten the bent sheets together permanently or temporarily.

Although described in the context of a heat shield, one will appreciate that the sheets and methods of the present inventions may be configured for a variety of applications. For example, one, two, three, or more sheets prepared for folding may be provided to form the resulting articles. As shown, for example, in FIG. 18-G, three sheets may be stacked on top of one another to form a 3D article or product. The sheets may also be configured for such stacking for the purposes of shipping intermediate, folded products. As would be understood from the foregoing, the sheets and bend lines may be modified depending on the application. Various components may be positioned on or attached to the sheets at various stages of the bending process. Other modifications to the sheets and methods described herein are intended to be within the scope of the present inventions.

For convenience in explanation and accurate definition in the appended claims, the terms “up” or “upper”, “down” or “lower”, “inside” and “outside” are used to describe features of the present invention with reference to the positions of such features as displayed in the figures.

The foregoing descriptions of the various embodiments of the present invention(s) have been presented for purposes of illustration and description. They are not intended to be exhaustive or to limit the invention(s) to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A two-dimensional sheet of material for bending along a bend line to form a three-dimensional article having a load-bearing bend line, the sheet comprising:
at least one bend-controlling displacement including:
a displaced portion displaced from the sheet of material in a thickness direction defined by a sheared face, the displaced portion further including a central portion extending along the bend line and opposing end portions at opposite ends of the central portion; and
a stem portion interconnecting the displaced portion to the remainder of the sheet of material, wherein the stem portion is located inwardly of the end portions and defined by opposing termini of the sheared face.

2. A sheet of material according to claim 1, wherein a maximum displacement distance of the central portion is at least approximately equal to the thickness of the sheet of material.

3. A sheet of material according to claim 1, wherein the central portion includes a planar zone substantially parallel to the sheet of material.

4. A sheet of material according to claim 3, the central portion further including opposing inclined portions extending from the planar zone.

5. A sheet of material according to claim 4, wherein the opposing ends define respective inclined portions.

6. A sheet of material according to claim 1, wherein the end portions extend at an angle between approximately 5° and approximately 10° relative to the surface of the sheet of material.

7. A sheet of material according to claim 1, wherein the outermost edges of the end portions are displaced a distance less than the thickness of the sheet of material.

8. A sheet of material according to claim 1, wherein the stem portion interconnects the displaced portion to the sheet along an interconnecting region partially defined by one or more ribs.

9. A sheet of material according to claim 8, wherein the interconnecting region is defined by opposing semispherical ribs located adjacent respective termini.

10. A sheet of material according to claim 1, the sheet of material including a plurality of displacements, wherein successive displacements are positioned on alternating sides of the bend line.

11. A sheet of material according to claim 1, the sheet including a plurality of displacements, wherein adjacent displacements define bending straps therebetween.

12. A sheet of material according to claim 11, wherein each of the end portions includes a substantially linear segment positioned and configured such that respective end portions of adjacent displacements on opposite sides of the bend line define substantially quadrilateral bending straps.

13. A method of preparing a two-dimensional sheet of material for bending along a bend line to form a three-dimensional article, the method comprising:
forming at least one bend-controlling displacement defining a bend line, the displacement including:
a displaced portion displaced from the sheet of material in a thickness direction defined by a sheared face, the displaced portion further including a central portion extending along the bend line and opposing end portions at opposite ends of the central portion; and
a stem portion interconnecting the displaced portion to the remainder of the sheet of material, wherein the stem portion is located inwardly of the end portions and defined by opposing termini of the sheared face.

14. A method according to claim 13, further including:
bending the sheet of material along the bend line whereby a balancing of the forces during bending draws a surface of the sheet on an opposite side of the bend line from the at least one displacement into engagement with the sheared face.

15. A method according to claim 13, wherein during the forming, a maximum displacement distance of the central portion is at least approximately equal to the thickness of the sheet of material.

16. A method according to claim 13, wherein the forming includes forming the central portion with a planar zone substantially parallel to the sheet of material.

17. A method according to claim 16, wherein the forming includes forming the central portion with opposing inclined portions extending from the planar zone.

18. A sheet of material according to claim 17, wherein the opposing ends define respective inclined portions.

19. A method according to claim 13, wherein the outermost edges of the end portions are displaced a distance less than the thickness of the sheet of material.

20. A method according to claim 13, wherein the stem portion interconnects the displaced portion to the sheet along an interconnecting region partially defined by one or more ribs.

21. A method according to claim 20, wherein the interconnecting region is defined by opposing semispherical ribs located adjacent respective termini.

22. A method according to claim 13, wherein the forming includes forming the sheet of material with a plurality of displacements, wherein successive displacements are positioned on alternating sides of the bend line.

23. A method according to claim 13, wherein the forming includes forming the sheet with a plurality of displacements, wherein adjacent displacements define bending straps therebetween.

24. A method according to claim 23, wherein each of the end portions includes a substantially planar segment positioned and configured such that respective end portions of adjacent displacements on opposite sides of the bend line define substantially quadrilateral bending straps.

25. A method of forming a 3D article, the method comprising:
forming a plurality of bend-controlling displacements to define a bend line in a two-dimensional sheet of material, at least a portion of the periphery of each displacement defining a sheared face, the forming including displacing at least one bend-controlling displacement in one thickness direction of the sheet and displacing another bend-controlling displacement in an opposite thickness direction of the sheet; and
precision bending a portion of the sheet of material along the bend line.

26. A method according to claim 25, wherein the plurality of bend-controlling displacements are positioned and configured to promote precision bending along the bend line in multiple directions.

27. A method according to claim 25, wherein the bending produces a balancing of the forces to draw the sheared face into engagement with a surface of the sheet on an opposite side of the bend line from the at least one displacement.

28. A method according to claim 25, further including:
preparing a second two-dimensional sheet of material substantially identical to the first sheet of material for bending along a bend line corresponding to the first sheet of material bend line; and
precision bending a portion of the second sheet of material along the corresponding bend line of the second sheet of material in a direction opposite to the bending of the first sheet of material.

29. A method according to claim 28, further including:
positioning the bent first sheet of material on top of the bent, second sheet of material such that a bent portion along the bend line of the first sheet of material is adjacent to an opposing bent portion along the bend line of the second sheet of material.

30. A method according to claim 29, further including:
fastening the first sheet of material to the second sheet of material to form a rigid, three-dimensional article.

31. A method according to claim 30, wherein the fastening is accomplished by interference fit.

32. A method according to claim 30, wherein the bend lines on the first and second sheets of material are positioned and configured such that at least one of the bent portions on the first sheet engages a corresponding bent portion on the second sheet during the positioning.

33. A method according to claim 25, wherein the sheet material is non-compressible.

34. A method according to claim 25, wherein the sheet material is a ductile metal.

35. A method according to claim 25, wherein during the forming, a maximum displacement distance of the displacement is approximately equal to the thickness of the sheet of material.

36. A method according to claim 35, wherein the maximum displacement is on a central portion of the displacement and end portions of the displacements are displaced a distance less than the thickness of the sheet of material.

37. A method according to claim 25, wherein the forming includes forming a central portion of the displacement with a planar zone substantially parallel to the sheet of material.

38. A method according to claim 37, wherein the forming includes forming the central portion with opposing inclined portions extending from the planar zone to the remainder of the sheet of material.

39. A method according to claim 25, wherein successive displacements are positioned on the same side of the bend line.

40. A method according to claim 25, wherein adjacent displacements define bending straps therebetween.

41. A method according to claim 40, wherein respective ends of adjacent displacements define bending half-straps.

42. A two-dimensional sheet of material for precision bending along a bend line to form a three-dimensional article, the sheet comprising:
a plurality of bend-controlling displacements displaced from the sheet of material in a thickness direction, at least a portion of the periphery of each displacement defining a sheared face,
wherein at least one of the plurality of bend-controlling displacement is displaced in one thickness direction and at least another of the plurality of bend-controlling displacements is displaced in an opposite thickness direction.

43. A sheet of material according to claim 42, wherein the one and another displacement are displaced in a direction substantially orthogonal to a plane defined by the sheet of material prior to bending.

44. A sheet of material according to claim 42, wherein a maximum displacement distance of the one and another displacement is approximately equal to the thickness of the sheet of material.

45. A sheet of material according to claim 42, wherein successive displacements are positioned on the same side of the bend line.

46. A sheet of material according to claim 45, wherein successive displacements are displaced on alternating sides of the sheet of material.

47. A sheet of material according to claim 42, wherein successive displacements are displaced on alternating sides of the sheet of material.

48. A method of forming a three-dimensional article from a two-dimensional sheet of material, the method comprising:
preparing a two-dimensional sheet of material according to claim 42; and
precision bending the sheet of material along the bend line into a three-dimensional article.

49. A rigid, three-dimensional article formed from a two-dimensional sheet of material, the article comprising:
a first sheet of material bent along at least one bend line defined by a plurality of bend-controlling displacements, at least a portion of the periphery of each displacement defining a sheared face, at least one bend-controlling displacement being formed in one thickness direction of the sheet prior to bending and at least another bend-controlling displacement being formed in an opposite thickness direction of the sheet; and
a second sheet of material substantially identical to the first sheet of material, the second sheet of material being attached to the first sheet of material,
wherein the second sheet of material is bent along a bend line corresponding to the at least one first sheet bend line in an opposite thickness direction, the bent first sheet of material being positioned on top of the bent second sheet of material such that a bent portion defined by the bend line of the first sheet of material opposes a bent portion defined by the corresponding bend line of the second sheet of material.

50. A method according to claim 49, wherein the first and second sheets of material are fastened together.

51. A method of forming a rigid, three-dimensional article, the method comprising:
preparing a first sheet of material for bending along a bend line defined by a plurality of displacements formed in a thickness direction of the sheet;
preparing a second sheet of material for bending along a bend line, the second sheet bend line defined by a plurality of displacements formed in a thickness direction of the sheet positioned and configured substantially identical to the first sheet of material such that the bend line in the second sheet of material corresponds to the bend line in the first sheet of material;
precision bending the first sheet of material along the first sheet bend line; and
precision bending the second sheet of material along the second sheet bend line in an opposite direction to the first sheet.

52. A method according to claim 51, further comprising:
positioning the first sheet adjacent to the second sheet such that a bent portion along the bend line of the first sheet of material is opposing a bent portion along the corresponding bend line of the second sheet of material.
